(19) United States
(12) Patent Application Publication
(10) Pub. No.: US 2026/0315925 A1
(43) Pub. Date: Oct. 15, 2026

(54) ELECTRONIC DEVICE AND OPERATION METHOD THEREOF

(71) Applicant: Samsung Electronics Co., Ltd., Suwon-si (KR)

(72) Inventors: Junho HWANG, Suwon-si (KR); Seunggoo LEE, Suwon-si (KR); Pureunsol KU, Suwon-si (KR); Sungho PARK, Suwon-si (KR); Sangjin LEE, Suwon-si (KR); Hoseock CHOI, Suwon-si (KR)

(73) Assignee: Samsung Electronics Co., Ltd., Suwon-si (KR)

(21) Appl. No.: 19/691,891

(22) Filed: May 29, 2026

Related U.S. Application Data
(63) Continuation of application No. PCT/KR2024/015991, filed on Oct. 21, 2024.

(30) Foreign Application Priority Data
Nov. 30, 2023 (KR) 10-2023-0171822

(51) Int. Cl. A63F 13/533; A63F 13/49; A63F 13/837

(52) U.S. Cl. CPC A63F 13/533; A63F 13/49; A63F 13/837

(57) ABSTRACT

An electronic device comprising a display; a memory to store one or more instructions; and at least one processor to execute the one or more instructions. The at least one processor executes the one or more instructions to: control the display to display game content through a first execution screen; control the display to display a second execution screen on the basis of a request for a menu through which a plurality of functions related to the game content can be set; and control the display to display the menu to include at least one function, on the second execution screen, selected from among the plurality of functions on the basis of the first execution screen and the second execution screen.

### CROSS-REFERENCE TO RELATED APPLICATIONS

This application is a continuation of International Application No. PCT/KR2024/015991, filed on Oct. 21, 2024 and also claims priority to Korean Patent Application 10-2023-0171822 filed on Nov. 30, 2023. The disclosures of each of which are incorporated by reference herein in their entireties.

### TECHNICAL FIELD

Various embodiments relate to an electronic device capable of streaming an execution screen of content being executed in a server, and an operation method thereof.

### BACKGROUND ART

Due to the development of technology for display devices, display devices capable of implementing various functions are being developed.

A representative example of a display device may include a television (TV). A conventional TV simply performs functions of receiving a broadcast signal and playing back broadcast content (e.g., news, dramas, entertainment programs, etc.) corresponding to the broadcast signal.

Recently, due to the technological development of display devices, various applications or programs to perform various functions may be stored and installed in a TV, and various functions and services in addition to a broadcast content playback function may be provided via the installed applications. For example, a game application may be stored and installed in a TV, and game content may be executed via the game application. In addition, as the number of game users increases, there is increasing demand for enjoying game contents via a large-screen TV for enhanced immersion in games.

A cloud game refers to a game service in which main operations such as graphic processing required for a game are performed on a cloud server, a user's manipulation input in a user device such as a smart phone or a smart TV is transmitted to the cloud server, and the user device receives a rendered game screen via Internet protocol (IP) streaming and displays the rendered game screen.

### DISCLOSURE OF INVENTION

### Solution to Problem

According to an embodiment, an electronic device may include a display, memory storing one or more instructions, and at least one processor configured to execute the one or more instructions.

The at least one processor may be configured to execute the one or more instructions to control the display to display a first execution screen of game content.

The at least one processor may be configured to execute the one or more instructions to, based on a request for a menu via which a plurality of functions related to the game content are settable, control the display to display a second execution screen.

The at least one processor may be configured to execute the one or more instructions to, based on the first execution screen and the second execution screen, control the display to display the menu to include at least one function that is providable in the second execution screen selected from among the plurality of functions.

According to an embodiment, an operation method of an electronic device may include displaying a first execution screen of game content.

According to an embodiment, the operation method of the electronic device may include receiving a request for a menu via which a plurality of functions related to the game content are settable.

According to an embodiment, the operation method of the electronic device may include displaying a second execution screen, based on the request for the menu.

According to an embodiment, the operation method of the electronic device may include, based on the first execution screen and the second execution screen, displaying the menu to include at least one function that is providable in the second execution screen selected from among the plurality of functions.

### BRIEF DESCRIPTION OF DRAWINGS

FIG. 1 is a diagram illustrating an operation in which an electronic device displays a content screen executed in a server, according to an embodiment.

FIGS. 2 to 5 are diagrams illustrating examples in which a display game screen is changed, when an electronic device receives a quick panel execution request, according to an embodiment.

FIG. 6 is a flowchart illustrating an example of an operation method of an electronic device, according to an embodiment.

FIG. 7 is a diagram illustrating an operation of analyzing a game screen changed in response to a quick panel execution request by an electronic device, according to an embodiment.

FIG. 8 is a diagram illustrating an operation in which an electronic device collects game pause screen data, according to an embodiment.

FIG. 9 is a diagram illustrating an operation in which an electronic device identifies functions that may be provided in a quick panel, according to an embodiment.

FIG. 10 is a diagram illustrating an operation in which an electronic device collects information about a sub-window corresponding to game content, according to an embodiment.

FIG. 11 is a diagram illustrating an operation in which an electronic device identifies functions that may be provided in a quick panel, according to an embodiment.

FIG. 12 is a diagram illustrating an operation in which an electronic device identifies functions that may be provided in a quick panel, according to an embodiment.

FIG. 13 is a diagram illustrating an operation in which an electronic device identifies functions that may be provided in a quick panel, according to an embodiment.

FIG. 14 is a diagram illustrating an operation in which an electronic device stores information about a function that may be provided for each game content, according to an embodiment.

FIG. 15 is a flowchart illustrating an operation method of an electronic device, according to an embodiment.

FIG. 16 is a diagram illustrating an operation in which an electronic device outputs a notification message when setting a position so as to apply a function to a game screen, according to an embodiment.

FIG. 17 is a diagram illustrating a system including an electronic device and a server, according to an embodiment.

FIG. 18 is a block diagram illustrating a configuration of a server, according to an embodiment.

FIG. 19 is a block diagram illustrating a configuration of an electronic device according to an embodiment.

FIG. 20 is a block diagram illustrating a configuration of an electronic device according to an embodiment.

### MODE FOR THE INVENTION

The terms used in the specification will be briefly defined, and the embodiments will be described in detail.

All terms including descriptive or technical terms which are used in the specification should be construed as having meanings that are obvious to one of ordinary skill in the art. However, the terms may have different meanings according to the intention of one of ordinary skill in the art, precedent cases, or the appearance of new technologies. Also, some terms may be arbitrarily selected by the applicant, and in this case, the meaning of the selected terms will be described in detail in the detailed description of the present disclosure. Therefore, the terms used in the present disclosure should not be interpreted based on only their names but have to be defined based on the meaning of the terms together with the descriptions throughout the specification.

When a part “includes” or “comprises” an element, unless there is a particular description contrary thereto, the part may further include other elements, not excluding the other elements. Furthermore, terms, such as “. . . unit,” “module,” etc., used herein indicate a unit for processing at least one function or operation, and may be implemented as hardware or software or a combination of hardware and software.

Hereinafter, the present disclosure will now be described more fully with reference to the accompanying drawings for one of ordinary skill in the art to be able to perform the embodiments without any difficulty. The present disclosure may, however, be embodied in many different forms and should not be construed as being limited to the embodiments set forth herein. In the drawings, parts irrelevant to the description are omitted for clarity, and like components are denoted by like reference numerals throughout the specification.

In an embodiment of the present specification, the term “user” refers to a person who controls a system, a function or an operation, and may include a developer, a manager, or an installation technician.

Also, in an embodiment of the present specification, an “image” or a “picture” may indicate a still image, a moving picture composed of a plurality of sequential still images (or frames), or a video.

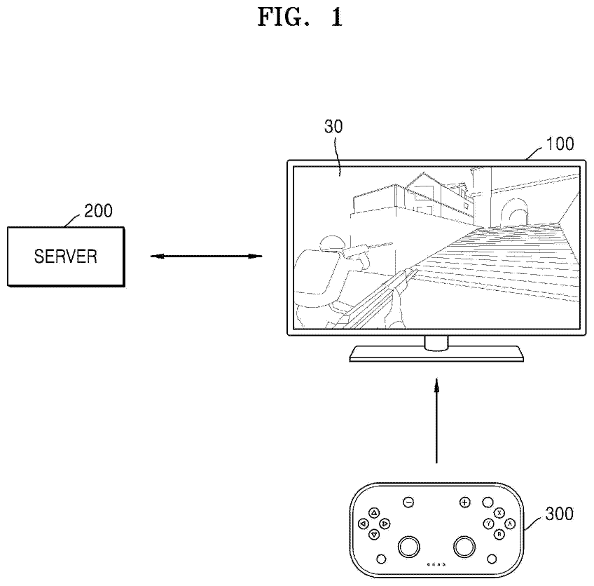

FIG. 1 is a diagram illustrating an operation in which an electronic device displays a content screen executed in a server, according to an embodiment.

Referring to FIG. 1, an electronic device 100 according to an embodiment may provide a gaming hub service that is a sub-service for game which provides connection to and control of a cloud game, a game console, etc., an optimized setting for an image quality or sound appropriate for games, and a driving function of a related application. The electronic device 100 may provide the gaming hub service by executing an application corresponding to the gaming hub service.

The electronic device 100 according to an embodiment may retrieve and execute games available in a cloud game and a console game device, based on the gaming hub service, and may perform general setting, external device control, etc., related to the games. The cloud game refers to a game service in which a user's manipulation input via a user terminal to a cloud server, and the cloud server executes main operations including graphic processing, etc., according to the user's manipulation input, renders a game screen, and transmits the rendered game screen to the user terminal via Internet protocol (IP) streaming.

The electronic device 100 according to an embodiment may be connected to a server 200 via wireless communication. The electronic device 100 according to an embodiment may be a stationary device or a mobile device. For example, the electronic device 100 may include an electronic device including a display and configured to display image content, video content, game content, graphic content, etc. Alternatively, the electronic device 100 may include various forms of electronic devices capable of receiving and outputting content, such as a television (TV) including a network TV, a smart TV, an Internet TV, a web TV, an IPTV, etc., a computer including a desktop computer, a laptop computer, a tablet computer, etc., a smartphone, a cellular phone, a game player, a music player, a video player, medical equipment, various smart devices including home appliances, or the like.

Alternatively, the electronic device 100 according to an embodiment may include an output port for outputting video/audio signals to an external display device so as to allow various types of content to be output via the external display device. In this regard, the output port may include a port for transmitting both a video signal and an audio signal, and ports for separately outputting a video signal and an audio signal. Also, the electronic device 100 may transmit video signals and audio signals corresponding to various types of content to the external display device via wireless communication. However, the present disclosure is not limited thereto.

The server 200 according to an embodiment may be a cloud server, a game server, but is not limited thereto. The electronic device 100 according to an embodiment may transmit a game content execution request to the server 200. When the server 200 receives the game content execution request from the electronic device 100, the server 200 may execute game content, and may transmit a result image or a result screen which is rendered according to execution of the game content to the electronic device 100 via a communication network. The electronic device 100 may control a result screen 30, which is received from the server 200, to be displayed on the display.

A controller 300 according to an embodiment may include various electronic devices such as a remote controller, a game controller, a smartphone, etc. The controller 300 may transmit a manipulation command for controlling content or an application providing the content corresponding to a content execution screen displayed on the electronic device 100, to the server 200 or the electronic device 100 via the communication network.

A user may manipulate the controller 300 to control the content or the application providing the content while viewing the content execution screen displayed on the electronic device 100, and the controller 300 may transmit the manipulation command according to the manipulation by the user to the electronic device 100 or the server 200.

The electronic device 100 according to an embodiment may provide a quick panel while the game content is being executed. For example, the quick panel may include a menu that provides frequently-used functions in a game, convenience functions provided in relation to the game, various settings related to the game, or the like. The user may quickly and conveniently access necessary menu via the quick panel, without shifting to a menu screen or navigating on a screen complexly.

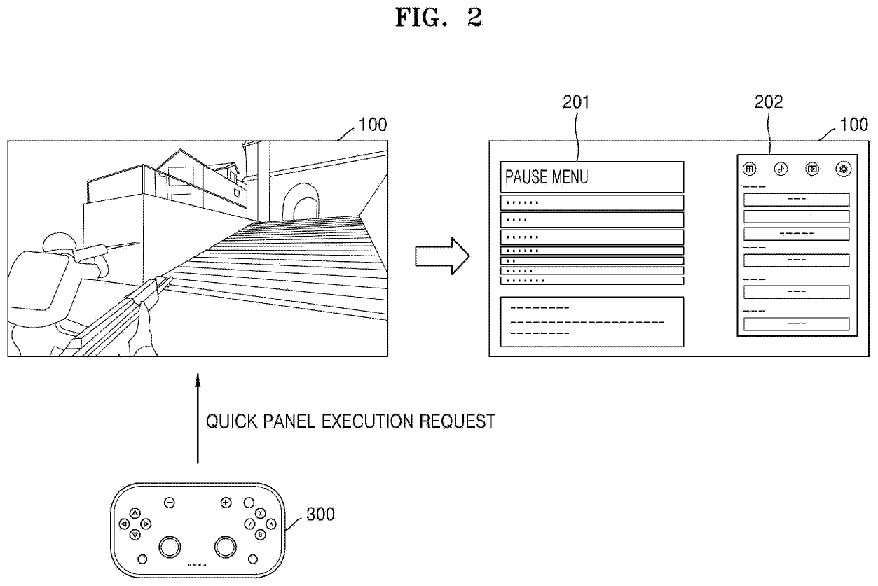

The electronic device 100 according to an embodiment may receive a quick panel execution request while the game content is being executed, and may control the quick panel to be displayed. When the quick panel execution request is received, a game content execution screen displayed on the electronic device 100 may be changed. This will be described in detail with reference to FIGS. 2 to 5.

According to an embodiment, as the game content execution screen is changed, there may be functions, among a plurality of functions provided via the quick panel, which cannot be provided via the changed execution screen. When the quick panel provides all the plurality of functions, regardless of whether they may be provided via the changed execution screen, the user may experience inconvenience in setting a corresponding function.

Accordingly, the electronic device 100 according to an embodiment may identify functions that may be provided via the changed execution screen, and may provide a quick panel via which only the identified functions are provided.

FIGS. 2 to 5 are diagrams illustrating examples in which a display game screen is changed, when an electronic device receives a quick panel execution request, according to an embodiment.

Referring to FIGS. 2 to 5, the electronic device 100 according to an embodiment may receive the quick panel execution request from the controller 300. In this regard, a user input for executing a quick panel may include a button input (e.g., an input of short-pressing or long-pressing a button) included in the controller 300, a touch input, a voice input, or the like. However, the present disclosure is not limited thereto. With respect to the voice input, a voice signal may be received via a microphone included in the controller 300 or may be received via a microphone included in the electronic device 100. However, the present disclosure is not limited thereto.

When a quick panel execution request is received, the electronic device 100 may inform the server 200 that an input via the controller 300 is not able to be transmitted to the server 200. For example, the electronic device 100 may transmit, to the server 200, data corresponding to a pause event due to execution of a quick panel.

When the server 200 according to an embodiment receives the data corresponding to the pause event due to execution of the quick panel from the electronic device 100, the server 200 may perform a preset operation, and may perform a different operation according to each game content being executed.

For example, referring to FIG. 2, when the server 200 receives data corresponding to a pause event during execution of first game content, the server 200 may transmit a pause menu screen 201 corresponding to the first game content to the electronic device 100. The electronic device 100 may display the pause menu screen 201 received from the server 200, and the pause menu screen 201 may be displayed as a full screen. When the pause menu screen 201 is displayed as the full screen, a gameplay screen may not be displayed on the display. Also, the electronic device 100 may display a quick panel 202.

In this manner, when the pause menu screen 201 is displayed as the full screen, some functions for which setting is necessary on the gameplay screen among functions that may be provided via the quick panel 202 may not be used.

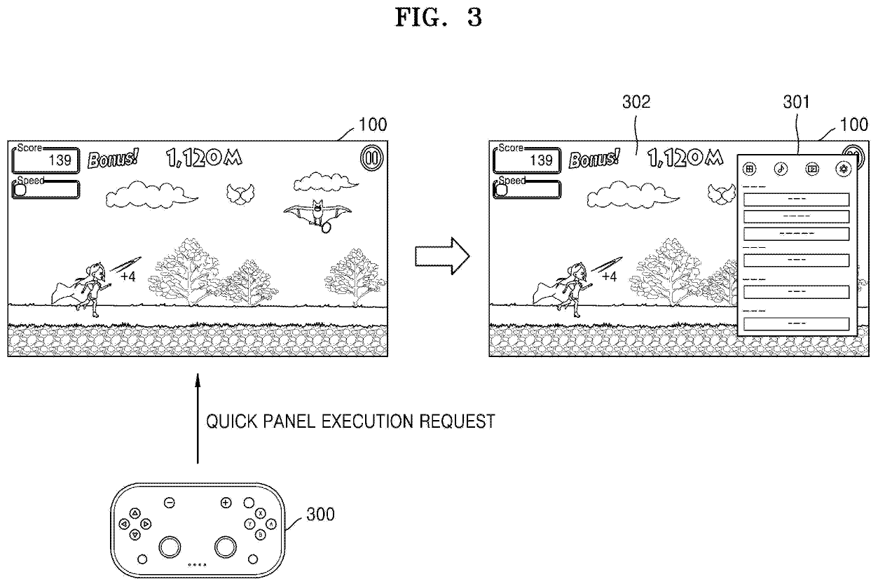

Also, referring to FIG. 3, when the server 200 receives data corresponding to a pause event during execution of second game content, the server 200 may pause game execution, and may transmit a paused game screen to the electronic device 100. Alternatively, the server 200 may not pause game execution but may transmit, while continuously executing a game, a gameplay screen to the electronic device 100.

The electronic device 100 may control a gameplay screen 302 received from the server 200 to be displayed. In this manner, as the gameplay screen 302 is displayed as-is even when a quick panel 301 is executed, functions for which setting is necessary on the gameplay screen 302 may be used.

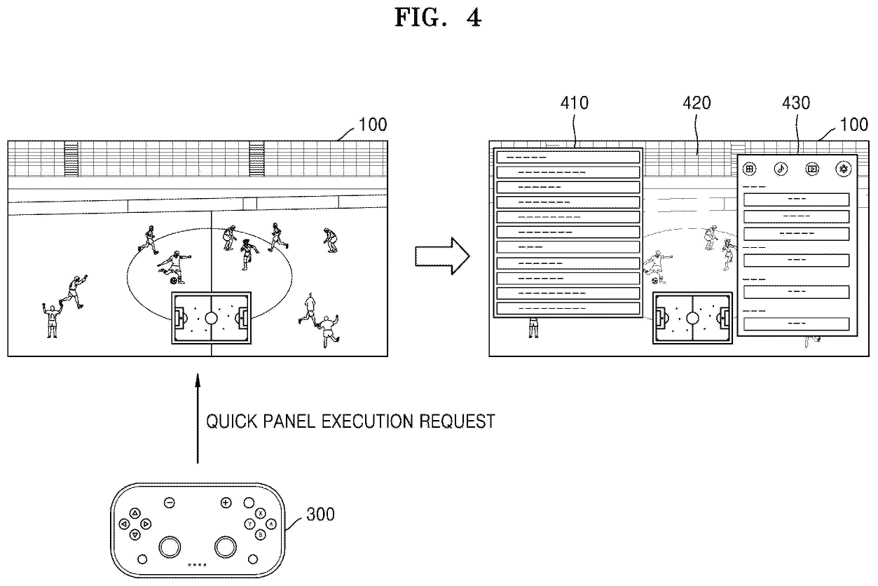

Alternatively, referring to FIG. 4, when the server 200 receives data corresponding to a pause event during execution of third game content, the server 200 may pause game execution, and may execute a pause menu 410 corresponding to the third game content. Also, the server 200 may transmit a game screen including the pause menu 410 to the electronic device 100. The electronic device 100 may control a game screen 420, which is received from the server 200, to be displayed. In this regard, the game screen 420 may be a screen including a pause menu 410 on a portion of the screen.

Accordingly, the portion of the game screen 420 may be hidden by the pause menu 410, and some functions in the hidden portion for which setting is necessary among functions that may be provided via a quick panel 430 may not be used.

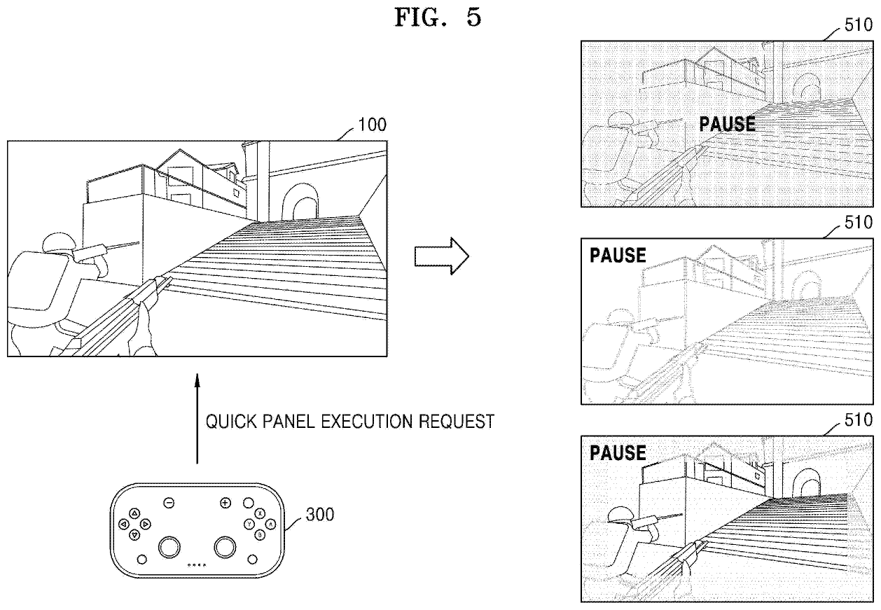

Also, referring to FIG. 5, when the server 200 receives data corresponding to a pause event while fourth game content is being executed, the server 200 may pause game execution and may change a color, transparency, a shade, or the like of the paused game screen. However, the present disclosure is not limited thereto.

Also, the server 200 may transmit a changed game screen to the electronic device 100. The electronic device 100 may control a game screen 510, which is received from the server 200, to be displayed. In this regard, the game screen 510 may be a screen in which a color, transparency, a shade, or the like have been changed.

Accordingly, a portion of a gameplay screen may not be identified due to a color, transparency, a shade, or the like of the game screen 510, and some functions in the unidentified portion for which setting is necessary among functions that may be provided via a quick panel may not be used.

As shown in FIGS. 2 to 5, according to an embodiment, a changed game screen displayed on a display after a quick panel request may vary for each game content, and functions that may be provided may vary according to a changed game screen.

Therefore, the electronic device 100 according to an embodiment may identify functions that may be provided in a changed game screen, by analyzing the changed game screen, and may provide a quick panel including only identified functions.

Hereinafter, with reference to drawings, a method by which the electronic device 100 according to an embodiment identifies functions that may be provided, and provides a quick panel configured to provide only the identified functions will be described in detail.

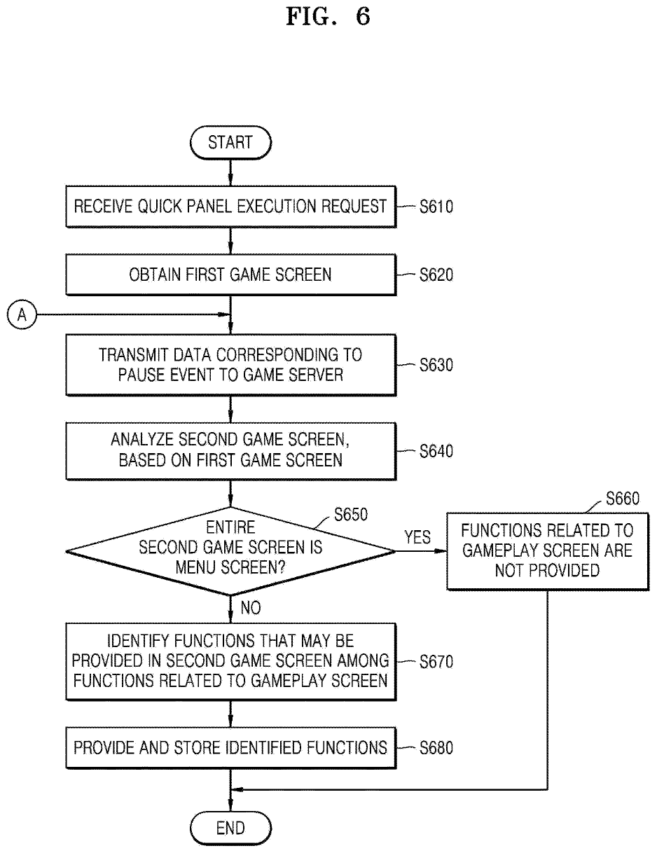

FIG. 6 is a flowchart illustrating an example of an operation method of an electronic device, according to an embodiment.

The electronic device 100 according to an embodiment may request the server 200 to execute game content, based on a gaming hub service. The server 200 may execute the game content, in response to the execution request of the game content, and may transmit, to the electronic device 100, a result image or a result screen which is rendered according to the execution of the game content.

Accordingly, the electronic device 100 may display the execution screen (game screen) of the game content.

Referring to FIG. 6, the electronic device 100 according to an embodiment may receive a quick panel execution request (S610). For example, the electronic device 100 may receive the quick panel execution request while displaying a game screen. The quick panel may include a menu that provides frequently-used functions in a game, convenience functions provided in relation to the game, various settings related to the game, or the like.

The electronic device 100 may receive a user input for executing a quick panel, the user input including a button input, a touch input, a voice input, or the like included in the controller 300. However, the present disclosure is not limited thereto.

When the quick panel execution request is received, the electronic device 100 according to an embodiment may obtain a first game screen (S620).

For example, the electronic device 100 may capture the first game screen displayed at a first time point at which the quick panel execution request is received or within a preset time range based on the first time point. The first game screen may include a screen in which a game is being executed.

The electronic device 100 according to an embodiment may transmit data corresponding to a pause event according to the quick panel execution request to the server 200 (S630).

For example, when the quick panel execution request is received, the electronic device 100 may inform the server 200 that an input of the controller 300 is not able to transmitted to the server 200 via a pause event.

The server 200 according to an embodiment may perform a preset operation when receiving the pause event, and the execution screen of the game content may be changed as the preset operation is performed.

Alternatively, even when the pause event is received, the server 200 may control, according to the game content, the game to continue without pausing the execution of the game.

The server 200 may transmit the changed game screen to the electronic device 100, and the electronic device 100 may display the changed game screen (e.g., a second game screen).

The electronic device 100 according to an embodiment may analyze the second game screen, based on the first game screen obtained in operation S620 (S640). The electronic device 100 may identify, by analyzing the second game screen, whether the entire second game screen is a menu screen or whether at least a portion of the second game screen includes a gameplay screen (S650).

When the entire second game screen is the menu screen (when the second game screen does not include the gameplay screen), the electronic device 100 may not provide functions related to the gameplay screen on the quick panel (S660). For example, the electronic device 100 may not provide functions that need to be set in the gameplay screen.

On the other hand, when the entire second game screen is not the menu screen (when at least the portion of the second game screen includes the gameplay screen), the electronic device 100 may identify functions that may be provided in the second game screen among functions related to the gameplay screen (S670).

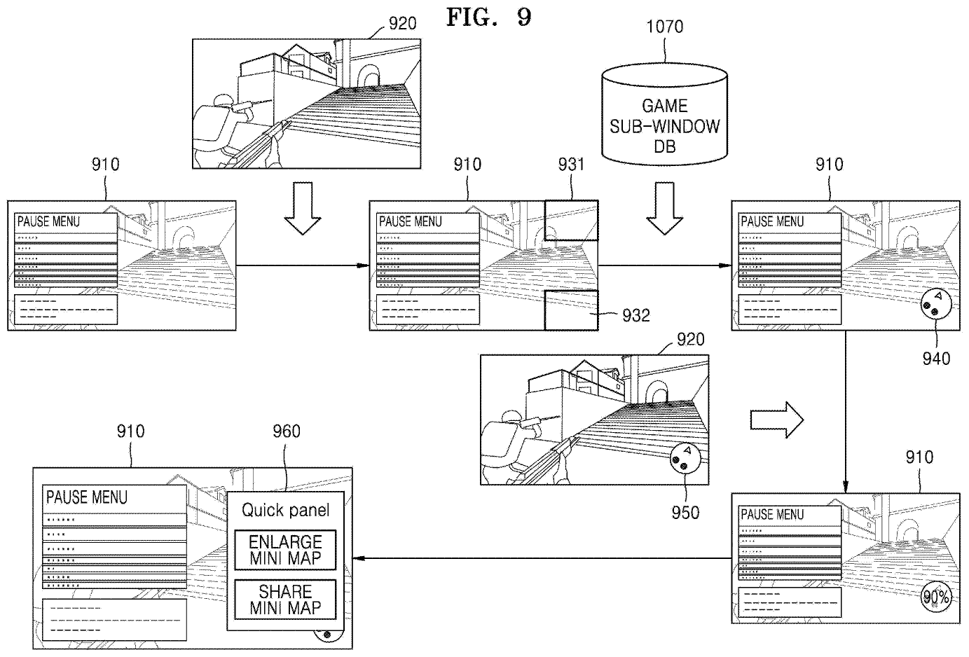

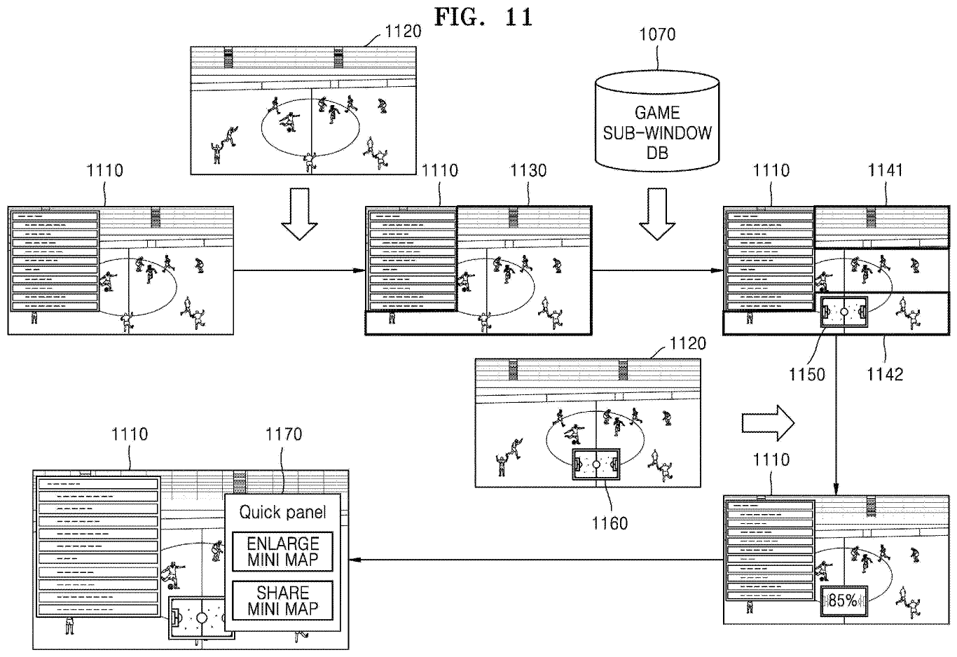

For example, the electronic device 100 may identify the functions that may be provided in the second game screen, based on the first game screen and the second game screen. The electronic device 100 may compare the first game screen with the second game screen, and thus, may set the gameplay screen in the second game screen as a candidate area and may detect a sub-window from the candidate area. The electronic device 100 may obtain sharpness information of the sub-window included in the second game screen, based on the sub-window included in the first game screen. The electronic device 100 may identify, based on the sharpness information, whether a function corresponding to the sub-window may be provided. This will be described in detail with reference to FIGS. 9 and 11.

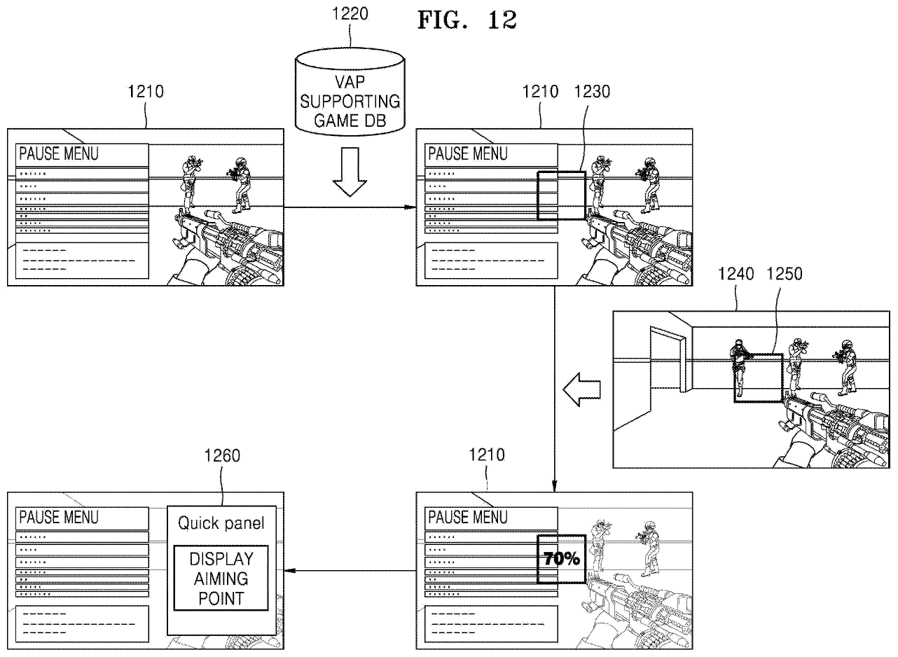

In addition, the electronic device 100 may obtain similarity information between the sub-window included in the second game screen and the sub-window included in the first game screen. The electronic device 100 may identify, based on the similarity information, whether the function corresponding to the sub-window may be provided. This will be described in detail with reference to FIG. 12.

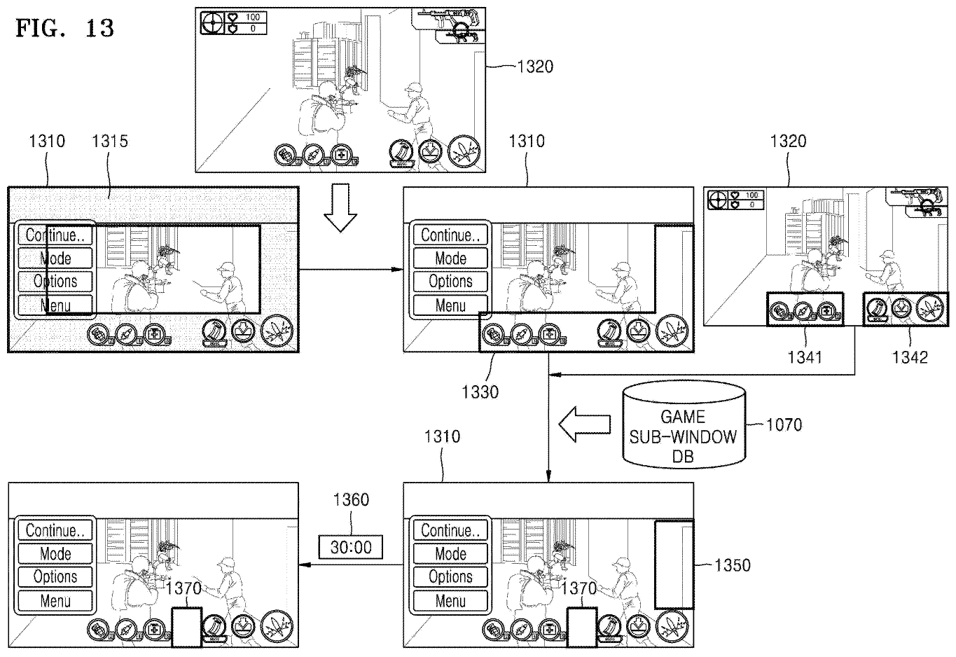

In addition, the electronic device 100 may identify a function that may be provided in a remaining area included in the second game screen, the remaining area excluding an area corresponding to the sub-window included in the first game screen in the candidate area (e.g., the gameplay screen). For example, the electronic device 100 may identify the function that may be provided in the remaining area, based on at least one of size, position, shape, and sharpness information of the remaining area. This will be described in detail with reference to FIG. 13.

In addition, when the second game screen includes a screen on which the game continues to be executed, the electronic device 100 may recognize a sub-window (e.g., a mini map, etc.) included in the second game screen by comparing and analyzing the first game screen and the second game screen. The electronic device 100 may identify that functions corresponding to the sub-window recognized from the second game screen may be provided

However, the method by which the electronic device 100 identifies the functions that may be provided in the second game screen among the functions related to the gameplay screen is not limited to the above-described examples.

The electronic device 100 according to an embodiment may provide the functions identified in operation S670 and may store analysis data corresponding to the game content (S680).

For example, the electronic device 100 may control a quick panel to be displayed, the quick panel being configured to provide only the functions identified in operation S670 among the functions related to the gameplay screen that may be provided in the quick panel.

In addition, the electronic device 100 may differently display the position and size of the quick panel, based on a result of the analysis on the second game screen. For example, the electronic device 100 may display the quick panel in a menu screen area of the second game screen, which is not the gameplay screen, thereby not obstructing a user from viewing the gameplay screen.

Alternatively, the position and size of the quick panel may be set or changed, based on a user input. However, the present disclosure is not limited thereto.

In addition, the electronic device 100 may store the information about the functions identified in operation S670 together with the information about the game content and the information about the sub-window of the game screen corresponding to the game content.

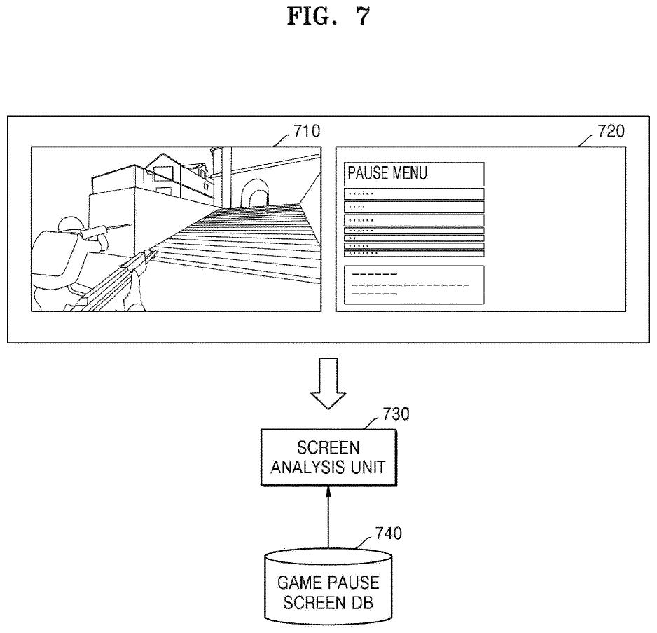

FIG. 7 is a diagram illustrating an operation of analyzing a game screen changed in response to a quick panel execution request by an electronic device, according to an embodiment.

Referring to FIG. 7, the electronic device 100 according to an embodiment may analyze whether an entire second game screen is a menu screen or at least a portion of the second game screen includes a gameplay screen, based on a first game screen 710 obtained before the quick panel execution request and a second game screen 720 changed in response to the quick panel execution request.

The electronic device 100 according to an embodiment may include a screen analysis unit 730. The screen analysis unit 730 may include an appropriate logic, circuit, interface, and/or code which is operated to identify whether the entire second game screen is the menu screen or whether at least a portion of the second game screen includes the gameplay screen.

For example, the screen analysis unit 730 may identify, by using an artificial intelligence (AI) technology based on a neural network, whether the entire second game screen is the menu screen or includes a portion of the gameplay screen.

The AI technology may include a visual understanding technology. The visual understanding refers to a technology for recognizing and processing objects like human vision, and may include object recognition, object tracking, image search, human recognition, scene understanding, spatial understanding, image improvement, or the like.

The electronic device 100 according to an embodiment may input information about the first game screen 710, the second game screen 720, and the game content to a pre-trained machine learning model, and thus, identify whether the entire second game screen 720 is the menu screen or at least the portion of the second game screen includes the gameplay screen. The information about the game content may include a game content name, genre information, or the like.

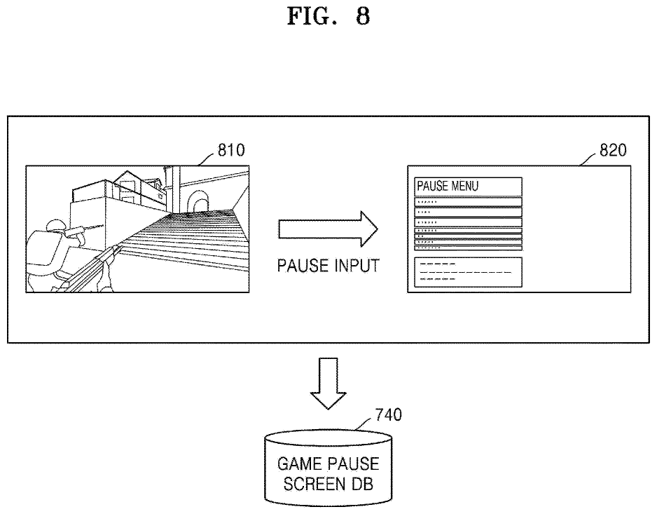

In addition, when it is identified that the entire second game screen is the menu screen, the screen analysis unit 730 may re-verify whether the entire second game screen is the menu screen, by using a game pause screen database (DB) 740. The game pause screen DB 740 will be described in detail with reference to FIG. 8.

FIG. 8 is a diagram illustrating an operation in which an electronic device collects game pause screen data, according to an embodiment.

Referring to FIG. 8, the electronic device 100 according to an embodiment may obtain information (e.g., gameplay screen data) about a gameplay screen 810 while a game is being executed.

In addition, when a pause input occurs while the game is being executed, the electronic device 100 may obtain information (e.g., pause screen data) about a screen 820 displayed after a preset time has elapsed from a time point when the pause input occurs.

The electronic device 100 may store information about game content (e.g., a game content name, genre information, etc.), the gameplay screen data, and the pause screen data in the game pause screen DB 740.

Also, the electronic device 100 may transmit the information about game content, the gameplay screen data, and the pause screen data to an external server. The external server may receive the information about game content, the gameplay screen data, and the pause screen data from other electronic devices as well as the electronic device 100 according to the embodiment. The external server may store the gameplay screen data and the pause screen data for each game content in the game pause screen DB, and may transmit the game pause screen DB stored in the external server to the electronic device 100 according to an embodiment.

Referring back to FIG. 8, the electronic device 100 may re-verify whether the entire second game screen 720 is the menu screen, by checking, based on the game pause screen DB 740, whether the second game screen 720 is the pause screen corresponding to the game content or whether the entire pause screen corresponding to the game content is the menu screen. However, the present disclosure is not limited thereto.

When the entire second game screen 720 is a menu screen, the electronic device 100 according to an embodiment may not provide functions related to the gameplay screen in the quick panel.

FIG. 9 is a diagram illustrating an operation in which an electronic device identifies functions that may be provided in a quick panel, according to an embodiment.

The electronic device according to an embodiment may provide a mini map related function via the quick panel. The mini map may include an image that displays a small map indicating an entire space in which a game is performed. The mini map related function may include a function of enlarging a mini map area or sharing the mini map area with an external device. However, the present disclosure is not limited thereto.

In order to use the mini map related function according to an embodiment, a mini map area has to be set in the game screen. In order to set the mini map area in the game screen, the mini map area has to be identifiable in the game screen.

Referring to FIG. 9, the electronic device 100 according to an embodiment may identify whether the mini map area may be identified in the changed second game screen, in response to the quick panel execution request.

The electronic device 100 according to an embodiment may obtain a mini map candidate area corresponding to the game content, based on the information about the game content. For example, the electronic device 100 may obtain corner areas of a second game screen 910 as mini map candidate areas, based on genre information (e.g., a shooting game) of the game content. Alternatively, the electronic device 100 may obtain a mini map candidate area, based on information about the mini map area corresponding to the game content, which is stored in the game sub-window DB.

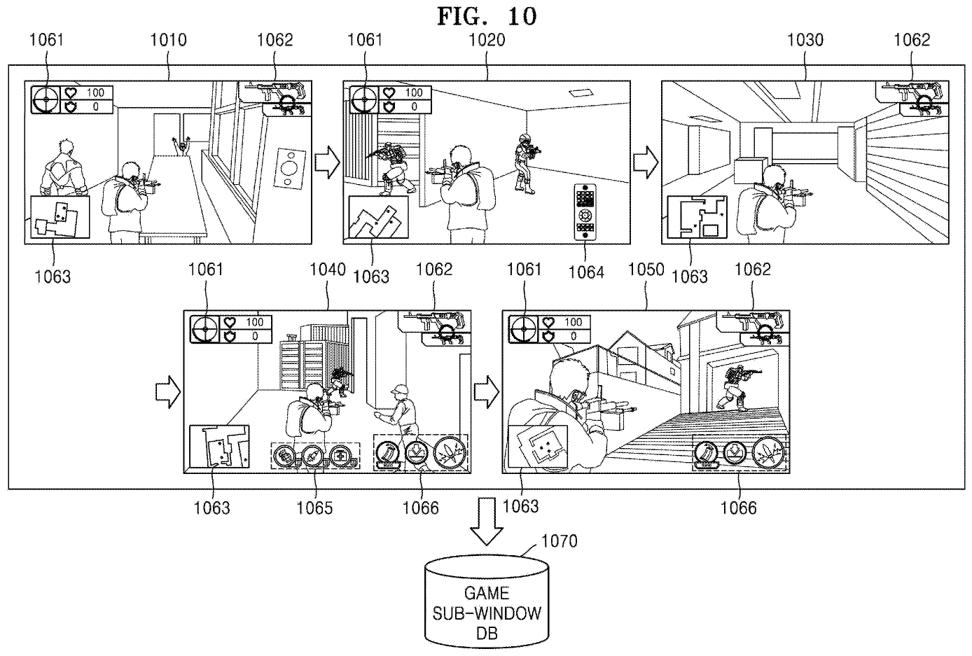

The game sub-window DB will be described in detail with reference to FIG. 10.

FIG. 10 is a diagram illustrating an operation in which an electronic device collects information about a sub-window corresponding to game content, according to an embodiment.

Referring to FIG. 10, the electronic device 100 according to an embodiment may collect information about a sub-window from a gameplay screen displayed during execution of a game.

The gameplay screen may include a separate sub-window that is distinguished from a game playback image. For example, the sub-window may be displayed in a partial area on the game playback image. However, the present disclosure is not limited thereto.

The sub-window may include information related to the progress of the game, a service (e.g., a chat window, etc.) for a game participant, or the like. The sub-window may include a mini map, a skill window, an item related window, a character related window, a chat window, a control related window, or the like. In addition, a type of sub-window included in the game image may vary depending on a type of game.

In particular, the mini map may include an image that displays a small map indicating an entire space in which the game is executed. The skill window may be a status window indicating the cool down time of the skill. The item related window may be a window that provides information about an item used in the game. For example, the item related window may include an item inventory window. The item inventory window may display a type and/or a reuse time of an item owned by the user. The character related window may be a window that provides information about a character performing the game. For example, the character related window may include a character status window. The character status window may be a window that provides a health point (HP) and/or a mana point (MP), a rehabilitation time, or the like of each of allies and/or enemies in a game such as a battle game in which the allies and the enemies exist. The chat window may be a window that displays chat contents of a plurality of people participating in a game or watching the game. Alternatively, the chat window may be a window for displaying a message related to the game.

The control related window may include a window for providing information related to a cockpit or a driver's seat in a game in which a game user adjusts an object (e.g., a flying object, a vehicle, etc.) used in the game. For example, the control related window may include a flight simulation cockpit window for providing information required or provided during flight or driving. The flight simulation driver window may display an air speed, an engine state, fuel, vertical control wings, a vehicle trim, an altitude state, or the like.

The sub-window according to an embodiment may be displayed in a separately partitioned area on the game image. Alternatively, the sub-window may be displayed in an opaque or translucent form on the partial area of the game image.

Referring to FIG. 10, the electronic device 100 according to an embodiment may extract sub-window candidate areas by storing frames 1010, 1020, 1030, 1040, and 1050 displayed during execution of game and performing image analysis on each of the frames 1010, 1020, 1030, 1040, and 1050. According to an embodiment, the electronic device 100 may extract the sub-window candidate areas by using an AI technology based on a neural network. In addition, the electronic device 100 may extract the sub-window candidate areas from the plurality of frames, based on the characteristics such as the position, size, shape, or the like of the sub-window.

The electronic device 100 may increase the score for the corresponding area each time the sub-window candidate area is extracted.

For example, referring to FIG. 10, the electronic device 100 may extract a first area 1061, a second area 1062, and a third area 1063 as sub-window candidate areas from the first frame 1010, and may increase the scores of the first area 1061, the second area 1062, and the third area 1063. In addition, in the second frame 1020, the first area 1061, the third area 1063, and a fourth area 1064 may be extracted as sub-window candidate areas, and the scores of the first area 1061, the third area 1063, and the fourth area 1064 may be increased. The electronic device 100 may extract sub-window candidate areas from the third frame 1030, the fourth frame 1040, and the fifth frame 1050 in the same manner, and may increase the scores of the corresponding areas. The electronic device 100 may identify, as the sub-windows, sub-window candidate areas having scores equal to or greater than a preset value, according to a result of analyzing the plurality of frames including the first to fifth frames 1010, 1020, 1030, 1040, and 1050. The electronic device 100 may store information about the sub-window in a game sub-window DB 1070 together with the information about the game content. For example, the information about the game content may include a game content name, genre information, or the like. The information about the sub-window may include the type, size, position, shape, etc. of the sub-window. However, the present disclosure is not limited thereto.

Referring back to FIG. 9, the electronic device 100 may exclude an area that is not the gameplay screen from the mini map candidate areas in the second game screen 910, based on the first game screen 920 obtained before the change.

Accordingly, the electronic device 100 may obtain, from the second game screen 910, a first candidate area 931 and a second candidate area 932 as final mini map candidate areas.

The electronic device 100 may identify a mini map in a mini map candidate area (e.g., the first candidate area 931 and the second candidate area 932), based on the game sub-window DB 1070.

For example, the electronic device 100 may detect a mini map area 940 from the mini map candidate area, based on the position, size, and shape information of the mini map included in the game sub-window DB 1070. However, the present disclosure is not limited thereto.

When the mini map area 940 is detected, the electronic device 100 may obtain sharpness information about the mini map area 940 detected in the second game screen 910. For example, the electronic device 100 may compare the sharpness of the mini map area (second mini map area) 940 of the second game screen 910 with the sharpness of the mini map area (first mini map area) 950 of the first game screen 920. The electronic device 100 may calculate a ratio of the sharpness of the second mini map area 940 to the sharpness of the first mini map area 950. For example, the sharpness of the second mini map area 940 may be 90% of the sharpness of the first mini map area 950.

The electronic device 100 may obtain a sharpness score based on the sharpness information of the second mini map area 940 and, when the sharpness score is greater than or equal to a preset value, may identify that a mini map related function may be provided.

Accordingly, the electronic device 100 may provide a mini map related function to a quick panel 960. For example, as shown in FIG. 9, the electronic device 100 may include and display an item indicating a mini map related function in the quick panel 960. However, the present disclosure is not limited thereto.

On the other hand, when the sharpness score of the second mini map area 940 is less than the preset value, the electronic device 100 may identify that the mini map related function is not able to be provided.

Accordingly, the electronic device 100 may not provide the mini map related function to the quick panel. For example, the electronic device 100 may not display an item indicating the mini map related function on the quick panel, or may display the item by deactivating the item. However, the present disclosure is not limited thereto.

FIG. 11 is a diagram illustrating an operation in which an electronic device identifies functions that may be provided in a quick panel, according to an embodiment.

The electronic device according to an embodiment may provide a mini map related function via a quick panel.

Referring to FIG. 11, the electronic device 100 according to an embodiment may identify whether a mini map area may be identified in a changed second game screen 1110, in response to the quick panel execution request.

The electronic device 100 according to an embodiment may obtain a gameplay screen area 1130 from the second game screen 1110, based on a first game screen 1120 obtained before the change.

The electronic device 100 may obtain a mini map candidate area from the gameplay screen area 1130. For example, the electronic device 100 may obtain a mini map candidate area included in the gameplay screen area 1130, based on the information about the genre information (e.g., sports game) of the game content. Alternatively, the electronic device 100 may obtain the mini map candidate area included in the gameplay screen area 1130, based on the information about the mini map corresponding to the game content, which is stored in the game sub-window DB 1070.

Accordingly, the electronic device 100 may obtain a first candidate area 1141 and a second candidate area 1142 as mini map candidate areas.

The electronic device 100 may identify a mini map in the mini map candidate area (e.g., the first candidate area 1141 and the second candidate area 1142), based on the game sub-window DB 1070.

For example, the electronic device 100 may detect a mini map area 1150 from the mini map candidate areas 1141 and 1142, based on position, shape, and size information of the mini map included in the game sub-window area DB. However, the present disclosure is not limited thereto.

When the mini map area 1150 is detected, the electronic device 100 may obtain sharpness information about the mini map area 1150 detected on the second game screen 1110. For example, the electronic device 100 may compare the sharpness of the mini map area (second mini map area) 1150 of the second game screen 1110 with the sharpness of a mini map area (first mini map area) 1160 of the first game screen 1120. The electronic device 100 may calculate a ratio of the sharpness of the second mini map area 1150 to the sharpness of the first mini map area 1160. For example, the sharpness of the second mini map area 1150 may be 85% of the sharpness of the first mini map area.

The electronic device 100 may obtain a sharpness score, based on the sharpness information of the second mini map area 1150 and, when the sharpness score is greater than or equal to a preset value, may identify that a mini map related function may be provided.

Accordingly, the electronic device 100 may provide the mini map related function to a quick panel 1170. For example, as shown in FIG. 11, the electronic device 100 may control the quick panel 1170 to be displayed as including item indicating the mini map related function. However, the present disclosure is not limited thereto.

On the other hand, when the sharpness score of the second mini map area 1150 is less than the preset value, the electronic device 100 may identify that the mini map related function is not able to be provided.

Accordingly, the electronic device 100 may not provide the mini map related function to the quick panel. For example, the electronic device 100 may control the quick panel not to display an item indicating the mini map related function or to display the item by deactivating the item. However, the present disclosure is not limited thereto.

FIG. 12 is a diagram illustrating an operation in which an electronic device identifies functions that may be provided in a quick panel, according to an embodiment.

The electronic device according to an embodiment may provide an aiming point related function via the quick panel. For example, the aiming point related function may include a function of displaying an aiming point.

The aiming point may be set in an aiming point area, and in order to set the aiming point, the aiming point area has to be identifiable on the game screen.

In response to a quick panel execution request, the electronic device 100 according to an embodiment may determine whether the game content being executed is a game requiring the aiming point related function, based on genre information about the game content being executed and genre information about game content providing the aiming point function (e.g., a virtual aim point (VAP) supporting game DB 1220).

When the genre of the game content is a genre that does not require the aiming point related function, the electronic device 100 may not provide the aiming point related function to the quick panel. For example, the electronic device 100 may control the quick panel not to display an item indicating the aiming point related function or to display the item by deactivating the item. However, the present disclosure is not limited thereto.

On the other hand, when the genre of the game content being executed is the genre requiring the aiming point related function, the electronic device 100 may determine whether the aiming point area may be identified in a second game screen 1210 changed in response to the quick panel execution request.

The electronic device 100 may obtain an aiming point area (e.g., an aiming point area 1230) in the second game screen 1210, based on the information about the aiming point area. The electronic device 100 may obtain similarity information indicating a degree to which the aiming point area 1230 in the second game screen 1210 is similar to a corresponding area 1250 in a first game screen 1240. The electronic device 100 may calculate a degree of similarity between the aiming point area 1230 and the corresponding area 1250 of the first game screen 1240. For example, the aiming point area 1230 may match the corresponding area 1250 of the first game screen 1240 by 70%.

The electronic device 100 may obtain a similarity score, based on the similarity information of the aiming point area 1230, and may determine that the aiming point related function may be provided when the similarity score is equal to or greater than a preset value.

Accordingly, the electronic device 100 may provide the aiming point related function to a quick panel 1260. For example, as shown in FIG. 12, the electronic device 100 may control the quick panel 1260 to be displayed as including an item indicating the aiming point related function. However, the present disclosure is not limited thereto.

On the other hand, when the similarity score of the aiming point area is less than the preset value, the electronic device 100 may determine that the aiming point related function is not able to be provided.

Accordingly, the electronic device 100 may not provide the aiming point related function to the quick panel. For example, the electronic device 100 may control the quick panel not to display an item indicating the aiming point related function or to display the item by deactivating the item. However, the present disclosure is not limited thereto.

FIG. 13 is a diagram illustrating an operation in which an electronic device identifies functions that may be provided in a quick panel, according to an embodiment.

The electronic device according to an embodiment may provide game related functions via the quick panel. For example, the game related functions may include an information display function including a frame per second (FPS) display function, a timer display function, or the like, in addition to the mini map related function and the aiming point related function described with reference to FIGS. 10 to 12. However, the present disclosure is not limited thereto.

Referring to FIG. 13, the electronic device 100 according to an embodiment may identify whether the timer display function may be provided in a changed second game screen 1310, in response to a quick panel execution request.

The electronic device 100 according to an embodiment may obtain a candidate area in which a timer may be displayed on the second game screen 1310. For example, the electronic device 100 may obtain an edge area of the second game screen 1310 as a candidate area 1315 for displaying the timer so as not to interfere with execution of the game.

The electronic device 100 may exclude an area of the second game screen 1310, which is not the gameplay screen, from the candidate area 1315, based on a first game screen 1320 obtained before the change.

Accordingly, the electronic device 100 may obtain, from the second game screen 1310, a first candidate area 1330 as a final candidate area.

The electronic device 100 may exclude, from the first candidate area 1330, an area in which a sub-window is already displayed. For example, the electronic device 100 may detect a game sub-window from the first game screen 1320, by using the game sub-window DB 1070.

Referring to FIG. 13, the electronic device 100 may exclude an area 1341 in which an item window is displayed and an area 1342 in which a mini map is displayed.

The electronic device 100 may compare the size and shape of a remaining candidate area 1350 with the size and shape of a timer object 1360, and thus, may identify whether the timer object 1360 may be displayed in the remaining candidate areas 1350 and 1370. The electronic device 100 may determine, as a final area, an area that is capable of displaying the timer object 1360 and is in the remaining candidate area 1350, and may obtain sharpness information of the final area. For example, the electronic device 100 may compare the sharpness of the final area 1370 of the second game screen 1310 with the sharpness of the corresponding area of the first game screen 1320. The electronic device 199 may calculate a ratio of the sharpness of the final area 1370 of the second game screen to the sharpness of the first game screen. For example, the sharpness of the final area 1370 may be 70% of the sharpness of the corresponding area of the first game screen 1320.

The electronic device 100 may obtain a sharpness score based on the sharpness information of the final area 1370, and when the sharpness score is greater than or equal to a preset value, may determine that the timer display function may be provided.

Accordingly, the electronic device 100 may provide the timer display function to the quick panel. For example, the electronic device 100 may include and display an item indicating the timer display function in the quick panel. However, the present disclosure is not limited thereto.

On the other hand, when the sharpness score of the final area 1370 is less than the preset value, the electronic device 100 may determine that the timer display function is not able to be provided.

Accordingly, the electronic device 100 may not provide the timer display function to the quick panel. For example, the electronic device 100 may not display an item indicating the mini map related function on the quick panel, or may display the item by deactivating the item. However, the present disclosure is not limited thereto.

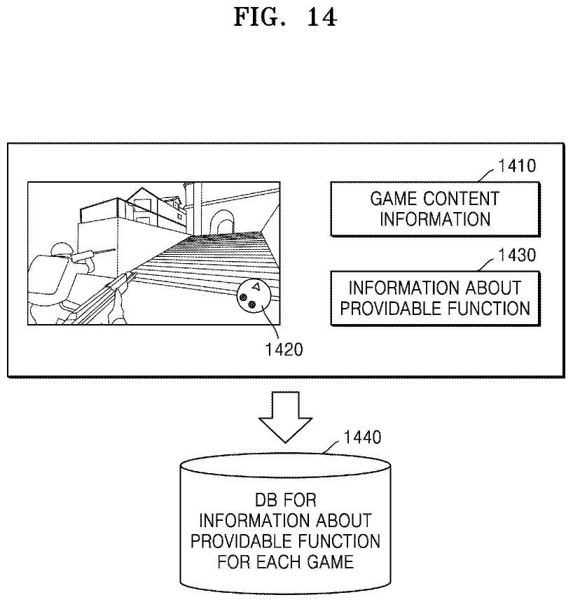

FIG. 14 is a diagram illustrating an operation in which an electronic device stores information about a function that may be provided for each game content, according to an embodiment.

Referring to FIG. 14, the electronic device 100 according to an embodiment may identify functions that may be provided in a quick panel while game content is being executed. Operations of identifying functions that may be provided in the quick panel while the electronic device 100 executes the game content are described in detail with reference to FIGS. 6 to 13, and thus, detailed descriptions thereof are omitted here.

The electronic device 100 may store a result of identifying functions that may be provided in the quick panel for each game content in a DB 1440.

For example, the electronic device 100 may store game content information 1410, game content sub-window information 1420, and information 1430 about at least one identified function that may be provided.

In this case, the game content information 1410 may include identification information (e.g., a game content name) for identifying the game content, genre information, or the like. In addition, the game content sub-window information 1420 corresponding to the game content may include information about a type, a position, a size, a shape, or the like of the sub-window displayed on the collected game screen when there is no game screen (first game screen) or quick panel execution request obtained before the screen is changed in response to the quick panel execution request.

In addition, the information 1430 about a function that may be provided in the game content may indicate whether each of functions that may be provided in the quick panel may be provided in a second game screen (the game screen changed in response to the quick panel execution request). For example, in a case of the first game content, the information 1430 about the function that may be provided in the game content may include information indicating that an aiming window display function is not provided, a mini map related function is provided, and a FPS or timer display function is provided. Alternatively, in a case of the second game content, the information 1430 about the function that may be provided in the game content may include information indicating that the aiming window display function is provided, the mini map related function is not provided, and the FPS or timer display function is provided. However, the present disclosure is not limited thereto.

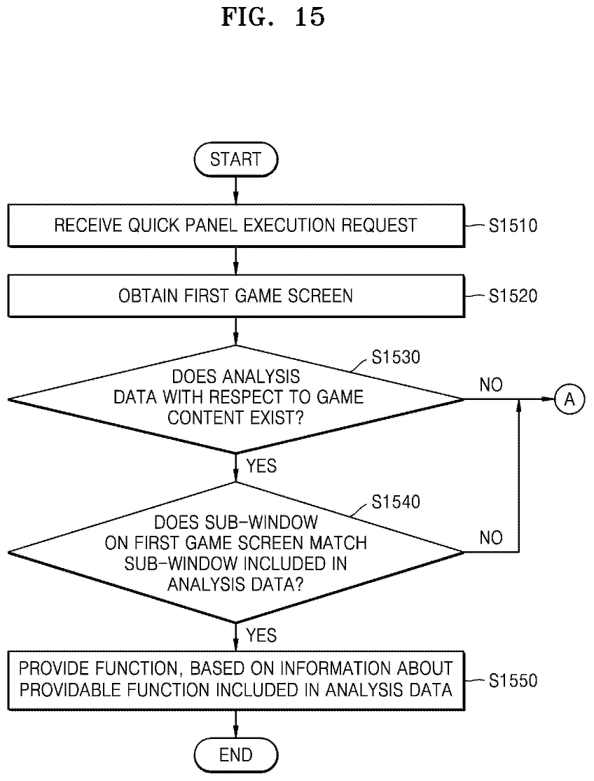

The electronic device 100 according to an embodiment may identify functions that may be provided in the quick panel when the quick panel execution request is received while the first game content is being executed. In this case, when result data for the first game content is pre-stored in the DB 1440 which stores information about a providable function for each game, the electronic device 100 may identify functions which may be provided in the quick panel by using the result data for the first game content. This will be described in detail with reference to FIG. 15.

FIG. 15 is a flowchart illustrating an operation method of an electronic device, according to an embodiment.

The electronic device 100 according to an embodiment may identify at least one function that may be provided in a quick panel during execution of game content, by using analysis data corresponding to the game content. The analysis data corresponding to the game content may include result data obtained by analyzing at least one function that may be provided in the quick panel when the game content is previously executed. The analysis data according to an embodiment may include data analyzed and stored in the electronic device 100. Alternatively, the analysis data may include data analyzed by other electronic devices. The electronic device 100 according to an embodiment may receive the analysis data from other electronic devices or a server. However, the present disclosure is not limited thereto.

Referring to FIG. 15, the electronic device 100 according to an embodiment may receive a quick panel execution request when game content is executed (S1510). For example, the electronic device 100 may receive the quick panel execution request while displaying a game screen. The quick panel may include a menu that provides frequently-used functions in a game, convenience functions provided in relation to the game, various settings related to the game, or the like.

The electronic device 100 may receive a user input for executing a quick panel, the user input including a button input, a touch input, a voice input, or the like included in the controller 300. However, the present disclosure is not limited thereto.

When the quick panel execution request is received, the electronic device 100 according to an embodiment may obtain a first game screen (S1520).

For example, the electronic device 100 may capture the first game screen displayed at a first time point at which the quick panel execution request is received or within a preset time range based on the first time point. The first game screen may include a screen in which a game is being executed.

The electronic device 100 according to an embodiment may determine whether first analysis data (e.g., data of at least one function that may be provided in the quick panel) corresponding to the game content (first game content) being executed exists (S1530).

When the first analysis data does not exist, the electronic device 100 may perform operations 630 (S630) to 680 (S680) described in FIG. 6. For example, the electronic device 100 may transmit data corresponding to a pause event according to the quick panel execution request to the server 200, and when the game screen is changed, may analyze the changed second game screen, based on the first game screen obtained in operation 1520 (S1520). In addition, the electronic device 100 may identify at least one function that may be provided in the second game screen among the functions that may be provided in the quick panel, based on a result of the analysis. As this process is described in detail with reference to FIGS. 6 to 14, detailed descriptions thereof are omitted here.

On the other hand, when the first analysis data exists, the electronic device 100 according to an embodiment may determine whether a sub-window included in the first game screen obtained in operation 1520 (S1520) matches a sub-window corresponding to the first game content included in the first analysis data (S1540).

For example, the electronic device 100 may determine whether a type, position, size, shape, or the like of the sub-window included in the first game screen match a type, position, size, shape, or the like of the sub-window corresponding to the first game content included in the first analysis data. A type, a position, a size, a shape, or the like of a sub-window displayed on a game content execution screen may be changed by a user. Accordingly, the type, the position, the size, the shape, or the like of the sub-window may be changed even in the same first game content. When the type, the position, the size, the shape, or the like of the sub-window are different from the type, position, size, shape, or the like of the sub-window included in the first analysis data, at least one function that may be provided by using the quick panel may not be identified by using the first analysis data.

Therefore, when the sub-window included in the first game screen does not match the sub-window corresponding to the first game content included in the first analysis data, the electronic device 100 may perform operations 630 (S630) to 680 (S680) described in FIG. 6.

On the other hand, when the sub-window included in the first game screen matches the sub-window corresponding to the first game content included in the first analysis data, the electronic device 100 may provide at least one providable function via the quick panel, based on information about the at least one providable function included in the first analysis data (S1550).

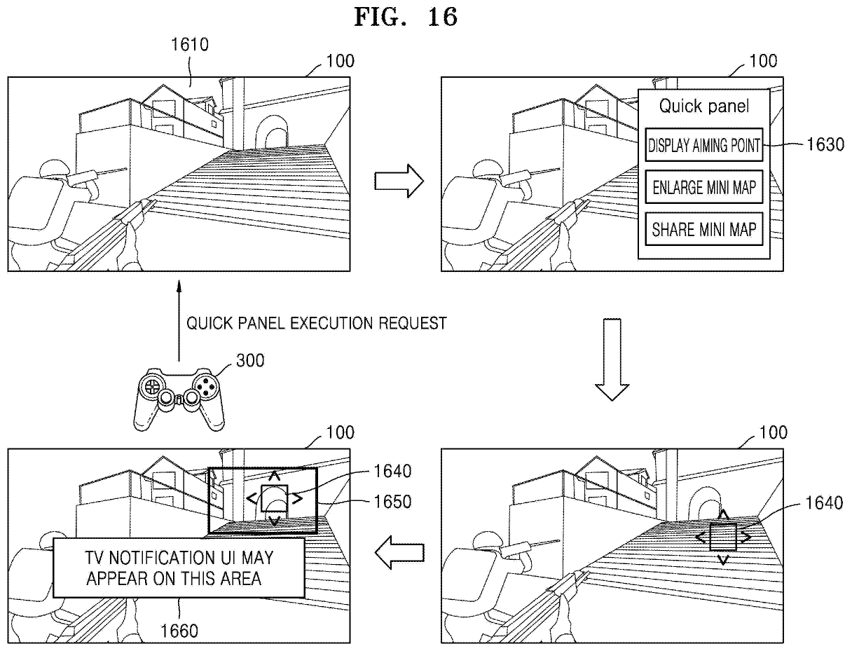

FIG. 16 is a diagram illustrating an operation in which an electronic device outputs a notification message when setting a position so as to apply a function to a game screen, according to an embodiment.

Referring to FIG. 16, the electronic device 100 according to an embodiment may receive a quick panel execution request while a game is being executed. For example, the electronic device 100 may receive the quick panel execution request while displaying an execution screen 1610 (game screen) of game content. The electronic device 100 may receive a user input for executing a quick panel, the user input including a button input, a touch input, a voice input, or the like included in the controller 300. However, the present disclosure is not limited thereto.

The electronic device 100 may control a quick panel 1620 to be displayed on the game screen, in response to the quick panel execution request. The quick panel 1620 according to an embodiment may include a menu that provides frequently-used functions in a game, convenience functions provided in relation to the game, various settings related to the game, or the like.

The electronic device 100 may receive an input of selecting a first item 1630 displaying an aiming point from the menu included in the quick panel 1620. The electronic device 100 may control an aiming window object 1640 to be displayed on the screen, in response to the first item selection input. The user may move and set the aiming window object 1640 on the game screen via the controller 300.

The electronic device 100 according to an embodiment may output a notification message when a position set by the user is not appropriate for setting the aiming window object 1640. For example, when the aiming window object 1640 is set in an area 1650 in which an information notification provided in the electronic device 100 or an information notification provided during the execution of game content is displayed, game execution by the user may be interfered, due to the displayed notification or the like.

Therefore, when an input of setting the aiming window object 1640 in the corresponding area 1650 is received, the electronic device 100 may output a notification message 1660 notifying that the corresponding area is an area where a notification or the like may appear. Accordingly, the user may set the aiming window object 1640 at another position.

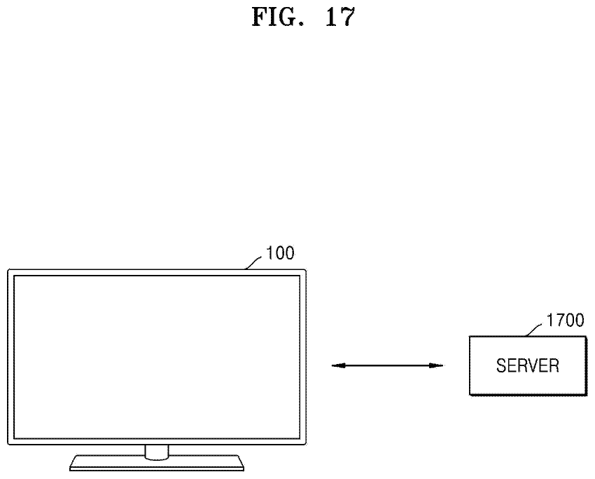

FIG. 17 is a diagram illustrating a system including an electronic device and a server, according to an embodiment.

Referring to FIG. 17, the electronic device 100 may be connected to a server 1700 via a network or short-range communication. The server 1700 according to an embodiment may correspond to the server 200 of FIG. 1 or another separate server. The electronic device 100 according to an embodiment may transmit a first game screen and a second game screen to the server 1700. As the first game screen and the second game screen are described in detail with reference to FIG. 6, detailed descriptions thereof are omitted here.

Alternatively, when the server 1700 is implemented as the server 200 of FIG. 1, the server 1700 may obtain the first game screen before receiving data corresponding to a pause event according to a quick panel execution request and the second game screen after receiving the data corresponding to the pause event.

According to an embodiment, the server 1700 may identify, by analyzing the second game screen based on the first game screen, whether the entire second game screen is a menu screen or whether at least a portion of the second game screen includes the gameplay screen. When the entire second game screen is the menu screen (when the second game screen does not include the gameplay screen), the server 1700 may transmit, to the electronic device 100, data indicating that functions related to the gameplay screen are not able to be provided in the quick panel.

The electronic device 100 may receive the data from the server 1700 and may not include, in the quick panel, functions that may be provided in the gameplay screen.

In addition, according to an embodiment, when the entire second game screen is not the menu screen (when at least the portion of the second game screen includes the gameplay screen), the server 1700 may identify functions that may be provided in the second game screen, based on the first game screen and the second game screen.

The server 1700 may receive, from the electronic device 100, information about functions related to the gameplay screen provided in the quick panel.

Also, the server 1700 may identify that functions that may be provided in the second game screen, based on the first game screen and the second game screen. The server 1700 may compare the first game screen with the second game screen, may set the gameplay screen of the second game screen as a candidate area, and may detect a sub-window from the candidate area. The server 1700 may obtain sharpness information of the sub-window included in the second game screen, based on the sub-window included in the first game screen. The server 1700 may identify, based on the sharpness information, whether a function corresponding to the sub-window may be provided.

Also, the server 1700 may obtain similarity information between a sub-window included in the second game screen and a sub-window included in the first game screen. The server 1700 may identify, based on the similarity information, whether the function corresponding to the sub-window may be provided.

In addition, the server 1700 may identify a function that may be provided in a remaining area included in the second game screen, the remaining area excluding an area corresponding to the sub-window included in the first game screen in the candidate area (e.g., the gameplay screen). For example, the server 1700 may identify a function that may be provided in the remaining area, based on at least one of size, position, shape, and sharpness information of the remaining area.

The server 1700 may transmit, to the electronic device 100, information about the functions identified as being providable in the second game screen among the functions related to the gameplay screen provided in the quick panel.

Based on the received information, the electronic device 100 may control a quick panel to be displayed, the quick panel including only the identified functions among the functions related to the gameplay screen that may be provided in the quick panel.

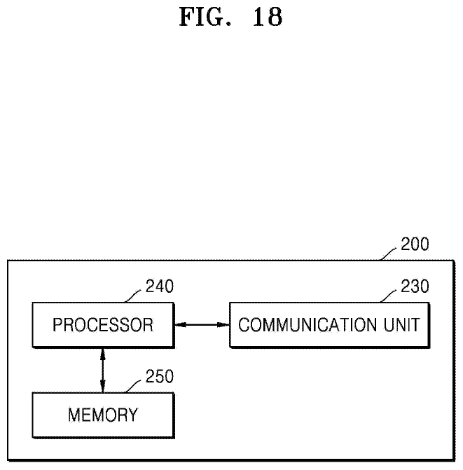

FIG. 18 is a block diagram illustrating a configuration of a server, according to an embodiment.

Referring to FIG. 18, the server 200 according to an embodiment may include a communication unit 230, a processor 240, and memory 250. The server 200 may be implemented with more elements than those shown in FIG. 17. For example, the server 200 may include a separate image processor for image processing of an image of game content executed in the server 200.

The communication unit 230 according to an embodiment may include one or more modules configured to enable wireless communication between the server 200 and a wireless communication system or between the server 200 and another device. For example, according to an embodiment, the communication unit 230 may perform communication with the electronic device 100 or the controller 300 according to an Internet protocol. However, the present disclosure is not limited thereto.

The communication unit 230 according to an embodiment may receive data corresponding to a pause event, according to a quick panel execution request from the electronic device 100. The memory 250 according to an embodiment may include at least one type of storage medium from among flash memory, a hard disk, a multimedia card micro, a memory card (e.g., a secure digital (SD) or extreme digital (XD) memory card), random access memory (RAM), static random access memory (SRAM), read-only memory (ROM), electrically erasable programmable read-only memory (EEPROM), programmable read-only memory (PROM), magnetic memory, a magnetic disk, and an optical disc.

The processor 240 according to an embodiment may control the overall operation of the server 200. For example, the processor 240 may execute one or more instructions or a program stored in the memory 250 to perform the operations or functions of the server 200 described in the embodiments of the present disclosure.

The processor 240 according to an embodiment may execute the one or more instructions stored in the memory 250 to receive a game content execution request from the electronic device 100, load and execute game content in response to the execution request, and transmit an image as a result of the execution to the electronic device 100.

The processor 240 according to an embodiment may receive data corresponding to a pause event according to the quick panel execution request from the electronic device 100. When the data corresponding to the pause event according to the quick panel execution request is received, a preset operation may be performed for each game content.

The block diagram of the server 200 shown in FIG. 18 is a block diagram for an embodiment. Component in the block diagram may be combined, a component may be added thereto, or at least one of the components may be omitted according to actual specifications of the server 200. That is, at least two components may be combined to one component, or one component may be divided into two components when necessary. Also, functions performed by each block are for describing the embodiments, and detailed operations or devices do not limit the scope of the present disclosure.

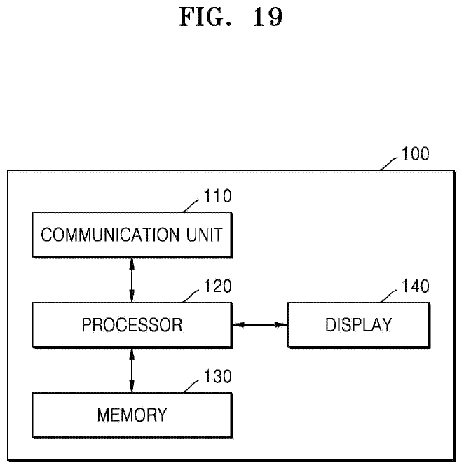

FIG. 19 is a block diagram illustrating a configuration of an electronic device according to an embodiment.

Referring to FIG. 19, the electronic device 100 according to an embodiment may include a communication unit 110, a processor 120, memory 130, and a display 140.

The communication unit 110 according to an embodiment may transmit and receive data or signals to and from an external device (e.g., the server 200 or the controller 300). For example, the communication unit 110 may include a Wi-Fi module, a Bluetooth module, an infrared communication module, a wireless communication module, a local area network (LAN) module, an Ethernet module, etc. In this case, each communication module may be implemented in the form of at least one hardware chip.

The Wi-Fi module and the Bluetooth module perform communication in a Wi-Fi method and a Bluetooth method, respectively. When the Wi-Fi module or the Bluetooth module is used, various types of connection information such as a service set identifier (SSID) and session key may be transmitted and received first, communication connection may be performed by using the connection information, and then various types of information may be transmitted and received. The wireless communication module may include at least one communication chip that performs communication according to various wireless communication standards such as ZigBee, 3^{rd} Generation (3G), 3^{rd} Generation Partnership Project (3GPP), Long Term Evolution (LTE), LTE Advanced (LTE-A), 4^{th} Generation (4G), 5^{th} Generation (5G), or the like.

The communication unit 110 according to an embodiment may request the server 200 to execute game content. In response to the execution request for the game content, the server 200 may execute the game content. The communication unit 110 may receive a result image or a result screen which is rendered according to the game content being executed by the server 200.

The communication unit 110 according to an embodiment may receive a control signal, a control command, or the like corresponding to a user input (e.g., a key or button input of a control device, or the like) from the controller 300.

The processor 120 according to an embodiment may control the overall operation of the electronic device 100 and a signal flow between internal components of the electronic device 100, and may perform a function of processing data.

The processor 120 may include single core, dual core, triple core, quad core, and multiple cores thereof. In addition, the processor 120 may include a plurality of processors. For example, the processor 120 may be implemented as a main processor (not shown) and a sub processor (not shown).

In addition, the processor 120 may include at least one of a central processing unit (CPU), a graphics processing unit (GPU), and a video processing unit (VPU). Alternatively, according to an embodiment, it may be implemented in the form of a system on chip (SoC) in which at least one of the CPU, the GPU, and the VPU is integrated. Alternatively, the processor 120 may further include a neural processing unit (NPU).

The memory 130 according to an embodiment may store various data, programs, or applications for driving and controlling the electronic device 100.

In addition, the program stored in the memory 130 may include one or more instructions. The program (the one or more instructions) or the application stored in the memory 130 may be executed by the processor 120.

The processor 120 according to an embodiment may execute the one or more instructions stored in the memory 130 to control the display 140 to display an execution screen of image content received from the server 200.

The image content according to an embodiment may include game content, movie content, music content, home training service content, broadcast content, or the like. For example, the processor 120 may control the execution screen (game screen) of the game content to be displayed.

The processor 120 according to an embodiment may receive a quick panel execution request while displaying the game screen. The quick panel may include a menu that provides frequently-used functions in a game, convenience functions provided in relation to the game, various settings related to the game, or the like.

For example, the processor 120 may receive a user input for executing the quick panel, the user input including a button input, a touch input, a voice input, or the like included in the controller 300.

The processor 120 according to an embodiment may execute the one or more instructions stored in the memory 130 to obtain a first game screen when the quick panel execution request is received. For example, the processor 120 may capture the first game screen displayed at a first time point at which the quick panel execution request is received or within a preset time range based on the first time point. The first game screen may include a screen in which a game is being executed.

The processor 120 according to an embodiment may execute the one or more instructions stored in the memory 130 to control the communication unit 110 to transmit a pause event according to the quick panel execution request to the server 200. For example, when the quick panel execution request is received, the processor 120 may inform the server 200 that an input of the controller 300 is not able to transmitted to the server 200 via a pause event.

The server 200 according to an embodiment may perform a preset operation when receiving data corresponding to the pause event, and the execution screen of the game content may be changed as the preset operation is performed.

The processor 120 according to an embodiment may receive the changed game screen from the server 200 via the communication unit 110. The processor 120 may control the display 140 to display the changed game screen (e.g., a second game screen).

The processor 120 according to an embodiment may execute the one or more instructions stored in the memory 130 to analyze the second game screen, based on the obtained first game screen.

According to an embodiment, the processor 120 may execute the one or more instructions stored in the memory 130 to identify, by analyzing the second game screen, whether the entire second game screen is a menu screen or whether at least a portion of the second game screen includes a gameplay screen. When the entire second game screen is the menu screen (when the second game screen does not include the gameplay screen), the processor 120 may not provide functions related to the gameplay screen in the quick panel. For example, the processor 120 may not provide functions that should be set in the gameplay screen.

According to an embodiment, the processor 120 may execute the one or more instructions stored in the memory 130 to identify functions that may be provided in the second game screen among the functions related to the gameplay screen when the entire second game screen is not the menu screen (when at least the portion of the second game screen includes the gameplay screen).

For example, the processor 120 may identify the functions that may be provided in the second game screen, based on the first game screen and the second game screen. The processor 120 may compare the first game screen with the second game screen, may set the gameplay screen of the second game screen as a candidate area, and may detect a sub-window from the candidate area. The processor 120 may obtain sharpness information of the sub-window included in the second game screen, based on the sub-window included in the first game screen. The processor 120 may identify, based on the sharpness information, whether the function corresponding to the sub-window may be provided. As this process is described in detail with reference to FIGS. 9 and 11, detailed descriptions thereof are omitted here.

In addition, the processor 120 may obtain similarity information between the sub-window included in the second game screen and the sub-window included in the first game screen. The processor 120 may identify, based on the similarity information, whether the function corresponding to the sub-window may be provided. As this process is described in detail with reference to FIG. 12, detailed descriptions thereof are omitted here.

In addition, the processor 120 may identify a function that may be provided in a remaining area included in the second game screen, the remaining area excluding an area corresponding to the sub-window included in the first game screen in the candidate area (e.g., the gameplay screen). For example, the processor 120 may identify the function that may be provided in the remaining area, based on at least one of size, position, shape, and sharpness information of the remaining area. As this process is described in detail with reference to FIG. 13, detailed descriptions thereof are omitted here.

However, the method by which the processor 120 identifies the functions that may be provided in the second game screen among the functions related to the gameplay screen is not limited to the above-described examples.

The processor 120 according to an embodiment may execute the one or more instructions stored in the memory 130 to provide functions identified as being providable in the second game screen via the quick panel, and may store the identified functions as analysis data corresponding to the game content.

For example, the processor 120 may control a quick panel to be displayed, the quick panel being configured to provide only the identified functions among the functions related to the gameplay screen that may be provided in the quick panel. In addition, the processor 120 may store the information about the identified functions together with the information about the game content and the information about the sub-window of the game screen corresponding to the game content.

The display 140 according to an embodiment may generate a driving signal by converting an image signal, a data signal, an on-screen display (OSD) signal, a control signal, or the like, which is processed by the processor 120. The display 140 may be implemented as a plasma display panel (PDP), a liquid crystal display (LCD), an organic light-emitting diode (OLED), a flexible display, or the like, and may also be implemented as a three-dimensional (3D) display. In addition, the display 140 may be configured as a touch screen, and thus, may be used not only as an output device but also as an input device.

The display 140 according to an embodiment may display an execution screen (game screen) of game content received from the server 200. In addition, the display 140 may display a quick panel configured to provide only functions identified as being providable in the second game screen.

In addition, the electronic device 100 according to an embodiment may not include the display 140, and may control a separate display device to display the execution screen (game screen) of the game content received from the server 200 or the quick panel. However, the present disclosure is not limited thereto.

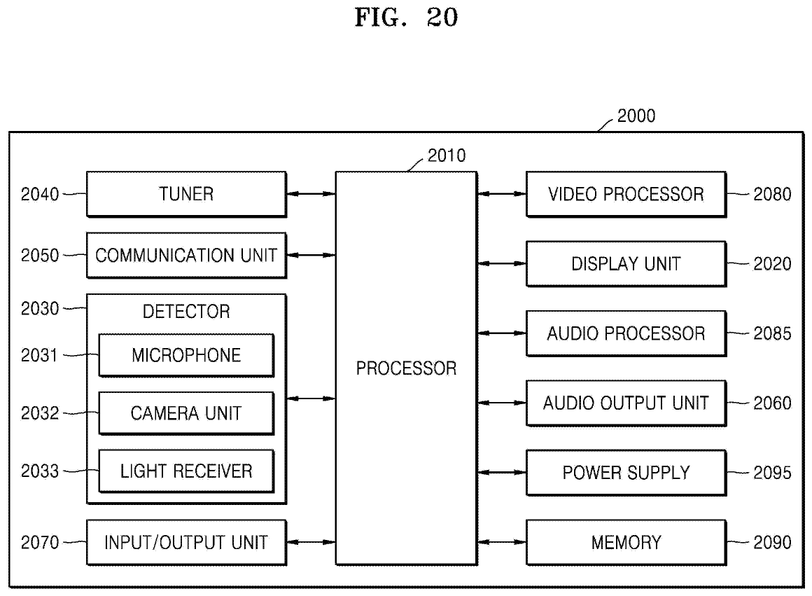

FIG. 20 is a block diagram illustrating a configuration of an electronic device according to an embodiment.

An electronic device 2000 of FIG. 20 may be an embodiment of the electronic device 100 described with reference to FIGS. 1 to 16.

Referring to FIG. 20, the electronic device 2000 according to an embodiment may include a tuner 2040, a processor 2010, a display unit 2020, a communication unit 2050, a detector 2030, an input/output unit 2070, a video processor 2080, an audio processor 2085, an audio output unit 2060, memory 2090, and a power supply 2095.

The communication unit 2050 of FIG. 20 may correspond to the communication unit 110 of FIG. 19, the processor 2010 of FIG. 20 may correspond to the processor 120 of FIG. 19, the memory 2090 of FIG. 20 may correspond to the memory 130 of FIG. 19, and the display unit 2020 of FIG. 20 may correspond to the display 140 of FIG. 19. Therefore, the same descriptions as those described above are omitted here.

The tuner 2040 according to an embodiment may tune and select only a frequency of a channel to be received by the electronic device 2000 among many radio wave components, via amplification, mixing, resonance, or the like of a broadcast signal received by wire or wirelessly. The broadcast signal includes audio, video, and additional information (e.g., an electronic program guide (EPG)).

The tuner 2040 may receive a broadcast signal from various sources such as terrestrial broadcasting, cable broadcasting, satellite broadcasting, Internet broadcasting, etc. The tuner 2040 may receive a broadcast signal from a source such as analog broadcasting or digital broadcasting.

The communication unit 2050 according to an embodiment may receive a control signal, a control command, or the like from an external control device. For example, the communication unit 2050 may include an infrared (IR) module capable of transmitting and receiving signals to and from the external control device according to an IR communication standard. In particular, the communication unit 2050 may receive a control signal or a control command corresponding to a user input (e.g., a key or button input of the control device) from the control device.

The detector 2030 according to an embodiment may detect a user's voice, a user's image, or a user's interaction, and may include a microphone 2031, a camera unit 2032, and a light receiver 2033.

The microphone 2031 receives a voice uttered by a user. The microphone 2031 may convert the received voice into an electrical signal and may output the electrical signal to the processor 2010. The user's voice may include, for example, a voice corresponding to a menu or function of the electronic device 2000. For example, the microphone 2031 may receive a user voice corresponding to a rotation command of the display, may convert the received voice into an electrical signal, and may output the electrical signal to the processor 2010.

The camera unit 2032 may receive an image (e.g., consecutive frames) corresponding to a user's motion including a gesture in a recognition range of a camera. The processor 2010 may select a menu displayed on the electronic device 2000 by using the received motion recognition result or may perform control corresponding to the motion recognition result. For example, the processor 2010 may receive an image from the camera unit 2032, may recognize a user's motion corresponding to rotation of the display from the received image, and may rotate the display, in response to the user's motion.

The light receiver 2033 receives an optical signal (including a control signal) received from an external control device via an optical window (not shown) of a bezel of the display unit 2020. The light receiver 2033 may receive an optical signal corresponding to a user input (e.g., a touch, a press, a touch gesture, a voice, or a motion) from the control device. A control signal may be extracted from the received optical signal under the control of the processor 2010.

The input/output unit 2070 according to an embodiment may receive video (e.g., moving pictures, etc.), audio (e.g., voice, music, etc.), and additional information (e.g., EPG, etc.) from the outside of the electronic device 2000. The input/output unit 2070 may include any one of a high-definition multimedia interface (HDMI), a mobile high-definition link (MHL), a universal serial bus (USB), a display port (DP), a thunderbolt, a video graphics array (VGA) port, an RGB port, a D-subminiature (D-SUB), a digital visual interface (DVI), a component jack, and a PC port.

The processor 2010 controls the overall operation of the electronic device 2000 and a signal flow between internal components of the electronic device 2000, and performs a function of processing data. When there is a user input or a preset-and-stored condition is satisfied, the processor 2010 may execute an operating system (OS) and various applications stored in the memory 2090.

The processor 2010 may include a RAM that stores a signal or data input from the outside of the electronic device 2000 or is used as a storage area corresponding to various operations performed by the electronic device 2000, a ROM that stores a control program for controlling the electronic device 2000, and a processor.

The video processor 2080 processes video data received by the electronic device 2000. The video processor 2080 may perform various types of image processing, such as decoding, scaling, noise cancelling, frame rate conversion, and resolution conversion, on the video data.

The audio processor 2085 processes audio data. The audio processor 2085 may perform various types of processing such as decoding, amplification, or noise cancelling on the audio data. The audio processor 2085 may include a plurality of audio processing modules to process audio corresponding to a plurality of pieces of content.

The audio output unit 2060 outputs audio included in a broadcast signal received via the tuner 2040 under the control of the processor 2010. The audio output unit 2060 may output audio (e.g., a voice or a sound) input via the communication unit 2050 or the input/output unit 2070. Also, the audio output unit 2060 may output audio stored in the memory 2090 under the control of the processor 2010. The audio output unit 2060 may include at least one of a speaker, a headphone output terminal, or a Sony/Philips Digital Interface (S/PDIF) output terminal.

The power supply 2095 supplies power input from an external power source to the internal components of the electronic device 2000 under the control of the processor 2010. In addition, the power supply 2095 may supply power output from one or two or more batteries (not shown) positioned inside the electronic device 2000 to internal components under the control of the processor 2010.

The memory 2090 may store various data, programs, or applications for driving and controlling the electronic device 2000 under the control of the processor 2010. The memory 2090 may include a broadcast receiving module, a channel control module, a volume control module, a communication control module, a voice recognition module, a motion recognition module, a light receiving module, a display control module, an audio control module, an external input control module, a power control module, a power control module for an external device connected wirelessly (e.g., Bluetooth), a voice DB, or a motion DB, which are not shown. The modules and database of the memory 2090, which are not shown, may be implemented in the form of software to perform a broadcast reception control function, a channel control function, a volume control function, a communication control function, a voice recognition function, a motion recognition function, a light reception control function, a display control function, an audio control function, an external input control function, a power control function, or a power control function for an external device connected wirelessly (e.g., Bluetooth) in the display device 2000. The processor 2010 may perform each function by using the software stored in the memory 2090.

The block diagrams of the electronic devices 100 and 2000 shown in FIGS. 19 and 20 are block diagrams for an embodiment. Component in the block diagram may be combined, a component may be added thereto, or at least one of the components may be omitted according to actual specifications of the electronic device 100 or 2000. That is, at least two components may be combined to one component, or one component may be divided into two components when necessary. Also, functions performed by each block are for describing the embodiments, and detailed operations or devices do not limit the scope of the present disclosure.

According to an embodiment, an electronic device may include a display, memory storing one or more instructions, and at least one processor configured to execute the one or more instructions.

The at least one processor may be configured to execute the one or more instructions to control the display to display a first execution screen of game content.

The at least one processor may be configured to execute the one or more instructions to, based on a request for a menu via which a plurality of functions related to the game content are settable, control the display to display a second execution screen.

The at least one processor may be configured to execute the one or more instructions to, based on the first execution screen and the second execution screen, execute the menu configured to provide only at least one function that is providable in the second execution screen and is among the plurality of functions.

The at least one processor may be configured to execute the one or more instructions to control the display to display a quick panel including the menu.

The plurality of functions may include at least one of a mini map related function, an aiming point display function, a FPS display function, and a timer display function.

According to an embodiment, the electronic device may further include a communication unit configured to receive an execution screen of the game content from an external device.

The at least one processor may be configured to execute the one or more instructions to, based on receiving the request for executing the menu, control the communication unit to transmit data corresponding to a pause event to the external device.

The at least one processor may be configured to execute the one or more instructions to, based on the first execution screen and the second execution screen obtained in response to receiving the request for the menu, when it is identified that the second execution screen does not include a gameplay screen, control the display to display the menu not including a function that is providable in the gameplay screen.

The at least one processor may be configured to execute the one or more instructions to, based on pause screen information of the game content, identify whether the second execution screen does not include the gameplay screen.

The at least one processor may be configured to execute the one or more instructions to obtain information about at least one of a type, a position, a size, and a shape of a sub-window of the game content by comparing gameplay screens of the game content.

The at least one processor may be configured to execute the one or more instructions to identify whether the second execution screen does not include the gameplay screen, by comparing the obtained first execution screen with the obtained second execution screen.

The at least one processor may be configured to execute the one or more instructions to, when it is identified that the second execution screen includes the gameplay screen, identify the gameplay screen in the second execution screen as a candidate area.

The at least one processor may be configured to execute the one or more instructions to, based on the candidate area, the information about the sub-window of the game content, and a sub-window included in the first execution screen, identify at least one function that is providable in the second execution screen.

The at least one processor may be configured to execute the one or more instructions to, based on the sub-window included in the first execution screen, obtain sharpness information about a sub-window included in the candidate area.

The at least one processor may be configured to execute the one or more instructions to, based on the sharpness information, identify whether a function corresponding to the sub-window is providable.

The at least one processor may be configured to execute the one or more instructions to obtain similarity information between the sub-window included in the first execution screen and the sub-window included in the candidate area.

The at least one processor may be configured to execute the one or more instructions to, based on the similarity information, identify whether a function corresponding to the sub-window is providable.

The at least one processor may be configured to execute the one or more instructions to, based on at least one of size, position, shape, and sharpness information of a remaining area in the candidate area, the remaining area excluding an area corresponding to the sub-window included in the first execution screen, identify whether the plurality of functions are providable.

The at least one processor may be configured to execute the one or more instructions to store information about a providable function for each content, the information including the information about the game content, information about the identified at least one function, and information about the first execution screen.

The at least one processor may be configured to execute the one or more instructions to, based on the information about the providable function for each content, identify at least one function that is providable in the second execution screen.

According to an embodiment, an operation method of an electronic device may include displaying a first execution screen of game content.

According to an embodiment, the operation method of the electronic device may include displaying a second execution screen, based on a request for a menu via which a plurality of functions related to the game content are settable.

According to an embodiment, the operation method of the electronic device may include, based on the first execution screen and the second execution screen, displaying the menu only including at least one function that is providable in the second execution screen and is among the plurality of functions.

The displaying of the menu may include displaying a quick panel including the menu.

The plurality of functions may include at least one of a mini map related function, an aiming point display function, a FPS display function, and a timer display function.

The displaying of the menu may include, based on the first execution screen and the second execution screen obtained in response to the request for the menu, when it is identified that the second execution screen does not include a gameplay screen, displaying the menu not including a function that is providable in the gameplay screen.

According to an embodiment, the operation method of the electronic device may further include obtaining information about at least one of a type, a position, a size, and a shape of a sub-window of the game content by comparing gameplay screens of the game content.

The displaying of the menu may include identifying whether the second execution screen does not include the gameplay screen, by comparing the obtained first execution screen with the obtained second execution screen.

The displaying of the menu may include, when it is identified that the second execution screen includes the gameplay screen, identifying the gameplay screen in the second execution screen as a candidate area.

The displaying of the menu may include, based on the candidate area, the information about the sub-window of the game content, and a sub-window included in the first execution screen, identifying at least one function that is providable in the second execution screen.

The displaying of the menu may include, based on the sub-window included in the first execution screen, obtaining sharpness information about a sub-window included in the candidate area.

The displaying of the menu may include, based on the sharpness information, identifying whether a function corresponding to the sub-window is providable.

The displaying of the menu may include obtaining similarity information between the sub-window included in the first execution screen and the sub-window included in the candidate area.

The displaying of the menu may include, based on the similarity information, identifying whether a function corresponding to the sub-window is providable.

According to an embodiment, the electronic device may provide, via a quick panel, only functions that may be provided in a game screen changed in response to a quick panel execution request, and thus, a user may easily set functions, and confusion may not occur to the user.

An operation method of an electronic device according to an embodiment may be embodied as programmed commands to be executed in various computer means, and then may be recorded to a computer-readable recording medium. The computer readable recording medium may include one or more of the programmed commands, data files, data structures, or the like. The programmed commands recorded to the computer readable recording medium may be particularly designed or configured for the present disclosure or may be well known to one of ordinary skill in the art. Examples of the computer-readable recording medium include magnetic media including hard disks, floppy disks, and magnetic tapes, optical media including CD-ROMs and DVDs, magneto-optical media including floptical disks, and hardware designed to store and execute the programmed commands in ROM, RAM, a flash memory, and the like. Examples of the programmed commands include not only machine code made by a compiler but also include a high-level programming language to be executed in a computer by using an interpreter.

Furthermore, an operation method of an electronic device according to the disclosed embodiments may be provided in a computer program product. The computer program product may be traded between a seller and a purchaser as a commodity.

The computer program product may include an S/W program and a computer-readable storage medium having stored therein the S/W program. For example, the computer program product may include a product (e.g. a downloadable application) in an S/W program distributed electronically through a manufacturer of an electronic device or an electronic market (e.g., Google Play Store and App Store). For electronic distribution, at least a part of the S/W program may be stored on the storage medium or may be generated temporarily. In this case, the storage medium may be a storage medium of a server of the manufacturer, a server of the electronic market, or a relay server for temporarily storing the S/W program.

In a system including a server and a client device, the computer program product may include a storage medium of the server or a storage medium of the client device. Alternatively, when there is a third device (e.g., a smartphone) that communicates with the server or the client device, the computer program product may include a storage medium of the third device. Alternatively, the computer program product may include an S/W program that is transmitted from the server to the client device or the third device or from the third device to the client device.

In this case, one of the server, the client device, and the third device may perform the method according to the disclosed embodiments by executing the computer program product. Alternatively, at least two of the server, the client device, and the third device may divide and perform the method according to the disclosed embodiments by executing the computer program product.

For example, the server (e.g., a cloud server, an AI server, or the like) may execute the computer program product stored in the server, thereby controlling the client device to perform the method according to the disclosed embodiments, the client device communicating with the server.

While the embodiments have been particularly described, the spirit and scope of the present disclosure may also include various changes and improvements in form and details which are made by one of ordinary skill in the art, in view of a basic concept of the present disclosure as defined by the appended claim.

1. An electronic device comprising:
a display;
memory to store one or more instructions; and
at least one processor configured to execute the one or more instructions to:
control the display to display game content through a first execution screen,
based on a request for a menu via which a plurality of functions related to the game content are settable, control the display to display a second execution screen, and
based on the first execution screen and the second execution screen, control the display to display the menu to include at least one function that is providable in the second execution screen selected from among the plurality of functions.

2. The electronic device of claim 1, wherein
the at least one processor is configured to execute the one or more instructions to control the display to display a quick panel comprising the menu, and
the plurality of functions comprise at least one of a mini map related function, an aiming point display function, a frame per second (FPS) display function, and a timer display function.

3. The electronic device of claim 1, further comprising:
a communication unit configured to receive an execution screen of the game content from an external device, and
the at least one processor is configured to execute the one or more instructions to, based on the request for the menu, control the communication unit to transmit data corresponding to a pause event to the external device.

4. The electronic device of claim 1, wherein the at least one processor is configured to execute the one or more instructions to,
based on the first execution screen and the second execution screen obtained in response to the request for the menu, when it is identified that the second execution screen does not comprise a gameplay screen, control the display to display the menu not comprising a function that is providable in the gameplay screen.

5. The electronic device of claim 4, wherein the at least one processor is configured to execute the one or more instructions to, based on pause screen information of the game content, identify whether the second execution screen does not comprise the gameplay screen.

6. The electronic device of claim 2, wherein the at least one processor is configured to execute the one or more instructions to obtain information associated with at least one of a type, a position, a size, and a shape of a sub-window of the game content by comparing gameplay screens of the game content.

7. The electronic device of claim 2, wherein the at least one processor is configured to execute the one or more instructions to:
identify whether the second execution screen does not comprise a gameplay screen, by comparing the first execution screen with the second execution screen,
based on the second execution screen being identified as comprising the gameplay screen, identify the gameplay screen in the second execution screen as a candidate area, and
based on the candidate area, information associated with a sub-window of the game content, and a sub-window comprised in the first execution screen, identify at least one function that is providable in the second execution screen.

8. The electronic device of claim 7, wherein the at least one processor is configured to execute the one or more instructions to,
based on the sub-window comprised in the first execution screen, obtain sharpness information associated with a sub-window comprised in the candidate area, and
based on the sharpness information, identify whether a function corresponding to the sub-window is providable.

9. The electronic device of claim 7, wherein the at least one processor is configured to execute the one or more instructions to
obtain similarity information between the sub-window comprised in the first execution screen and the sub-window comprised in the candidate area, and
based on the similarity information, identify whether a function corresponding to the sub-window is providable.

10. The electronic device of claim 7, wherein the at least one processor is configured to execute the one or more instructions to, based on at least one of size, position, shape, and sharpness information of a remaining area in the candidate area, the remaining area excluding an area corresponding to the sub-window comprised in the first execution screen, identify whether the plurality of functions are providable.

11. The electronic device of claim 1, wherein the at least one processor is configured to execute the one or more instructions to
store information associated with a providable function for a respective content, the information associated with the providable function comprising the information associated with the game content, information associated with the at least one function, and information associated with the first execution screen.

12. The electronic device of claim 11, wherein the at least one processor is configured to execute the one or more instructions to, based on the information associated with a respective function that is providable for each content, identify the at least one function that is providable in the second execution screen.

13. An operation method of an electronic device, the operation method comprising:
displaying game content through a first execution screen;
receiving a request for a menu via which a plurality of functions related to the game content are settable;
displaying a second execution screen, based on the request for the menu; and
based on the first execution screen and the second execution screen, displaying the menu to include at least one function that is providable in the second execution screen selected from among the plurality of functions.

14. The operation method of claim 13, wherein
the displaying of the menu comprises displaying a quick panel comprising the menu, and
the plurality of functions comprise at least one of a mini map related function, an aiming point display function, a frame per second (FPS) display function, and a timer display function.

15. A non-transitory computer-readable recording medium having stored therein a program to cause the electronic device to perform the operation method of claim 13.
